(19) United States
(12) Patent Application Publication
(10) Pub. No.: US 2006/0218191 A1
(43) Pub. Date: Sep. 28, 2006

(54) Method and System for Managing Multimedia Documents

(76) Inventor: Kumar C. Gopalakrishnan, Mountain View, CA (US)

Correspondence Address: Kumar C. Gopalakrishnan, P.O. Box 2002, Mountain View, CA, 94042, US

(21) Appl. No.: 11/423,234

(22) Filed: Jun. 9, 2006

Related U.S. Application Data
(63) Continuation-in-part of application No. 11/215,601, filed on Aug. 30, 2005.
(60) Provisional application No. 60/689,345, filed on Jun. 10, 2005.
(60) Provisional application No. 60/689,613, filed on Jun. 10, 2005.
(60) Provisional application No. 60/689,618, filed on Jun. 10, 2005.
(60) Provisional application No. 60/689,741, filed on Jun. 10, 2005.
(60) Provisional application No. 60/689,743, filed on Jun. 10, 2005.
(60) Provisional application No. 60/606,282, filed on Aug. 31, 2004.

(51) Int. Cl. G06F 17/00

(52) U.S. Cl. 707/104.1

(57) ABSTRACT

A method and system authors multimedia documents from multimodal inputs. Also described are management, retrieval, and presentation of documents from the system.

### CROSS-REFERENCE TO RELATED APPLICATIONS

This application claims the benefit of U.S. provisional patent applications 60/689,345, 60/689,613, 60/689,618, 60/689,741, and 60/689,743, all filed Jun. 10, 2005, and is a continuation in part of U.S. patent application Ser. No. 11/215,601, filed Aug. 30, 2005, which claims the benefit of U.S. provisional patent application 60/606,282, filed Aug. 31, 2004. These applications are incorporated by reference along with any references cited in this application.

### BACKGROUND OF THE INVENTION

The present invention relates to authoring, managing, and retrieval of multimedia documents. In particular, the invention relates to the authoring, managing, and retrieval of multimedia documents using computer analysis of the documents.

As the cost of the digital image sensors used in digital photographic equipment dropped, they were incorporated into various devices such as cellular phones and personal digital assistants (PDAs) enabling ubiquitous access to digital photography equipment. With the ubiquitous availability of inexpensive digital photography and video equipment, the use of visual content such as still images and video is no longer restricted to recording of important events. This has resulted in an explosion in the volume of visual content to be managed.

Consumers store their digital visual content on personal computers or Web-based hosting services and manage the pictures through explicit metadata associated with the content such as the time of its capture, filenames, and folders. Businesses such as publishers and television broadcasters store their large visual content libraries in digital asset management systems that offer better storage, retrieval, and management features than what is available to consumers. Features available in such digital asset management systems include the extraction of embedded information from the content to aid in management of the content.

While the above discussion focuses on tools for visual content capture and management, audio content evolved through a similar progression from analog audio tapes through digitized audio in CDs to end-to-end digital systems. In the process, tools available for the capture and management of audio content are also limited in functionality similar to the tools available for video. Moreover, video content is invariably associated with corresponding audio and hence tools for video capture and management are often multimedia capture and management tools that include support for audio.

Given the immense amount of multimedia information generated by everyone, especially consumers, a better solution for capturing of multimedia information, for the composition of the multimedia information into documents and for managing the documents, is in order.

### BRIEF SUMMARY OF THE INVENTION

A method and system for authoring, management, and retrieval of multimedia documents from multimodal information is described. The multimedia documents may be composed from a plurality of multimodal information such as multimedia content sequences, associated metadata, user inputs, and information derived from knowledge bases. The system optionally extracts information from the multimodal information to aid the authoring, management, retrieval, and presentation of multimedia documents. In addition, the documents may be associated with related information services. The documents in the system may also be shared among users, communicated to other users, and have access restrictions specified for various users. Further, the use of documents in the system may also be accompanied by financial transactions.

Other objects, features, and advantages of the present invention will become apparent upon consideration of the following detailed description and the accompanying drawings, in which like reference designations represent like features throughout the figures.

### BRIEF DESCRIPTION OF THE DRAWINGS

FIG. 1 illustrates an exemplary system, in accordance with an embodiment.

FIG. 2 illustrates an alternative view of an exemplary system, in accordance with an embodiment.

FIG. 3(a) illustrates a front view of an exemplary client device, in accordance with an embodiment.

FIG. 3(b) illustrates a rear view of an exemplary client device, in accordance with an embodiment.

FIG. 4 illustrates another alternative view of an exemplary system, in accordance with an embodiment.

FIG. 5(a) illustrates an exemplary login view of a user interface, in accordance with an embodiment.

FIG. 5(b) illustrates an exemplary settings view of a user interface, in accordance with an embodiment.

FIG. 5(c) illustrates an exemplary author view of a user interface, in accordance with an embodiment.

FIG. 5(d) illustrates an exemplary home view of a user interface, in accordance with an embodiment.

FIG. 5(e) illustrates an exemplary index view of a user interface, in accordance with an embodiment.

FIG. 5(f) illustrates an exemplary folders view of a user interface, in accordance with an embodiment.

FIG. 5(g) illustrates an exemplary content view of a user interface, in accordance with an embodiment.

FIG. 5(h) illustrates an alternative exemplary content view of a user interface, in accordance with an embodiment.

FIG. 5(i) illustrates an alternative index view of a user interface, in accordance with an embodiment.

FIG. 5(j) illustrates an alternative content view of a user interface, in accordance with an embodiment.

FIG. 6 illustrates an exemplary message structure, in accordance with an embodiment.

FIG. 7(a) illustrates an exemplary user access privileges table, in accordance with an embodiment.

FIG. 7(b) illustrates an exemplary user group access privileges table, in accordance with an embodiment.

FIG. 7(c) illustrates an exemplary documents classifications table, in accordance with an embodiment.

FIG. 7(d) illustrates an exemplary user groups table, in accordance with an embodiment.

FIG. 7(e) illustrates an exemplary documents ratings table listing individual users' ratings, in accordance with an embodiment.

FIG. 7(f) illustrates an exemplary documents ratings table listing user groups' ratings, in accordance with an embodiment.

FIG. 7(g) illustrates an exemplary aggregated documents ratings table for users and user groups, in accordance with an embodiment.

FIG. 7(h) illustrates an exemplary author ratings table, in accordance with an embodiment.

FIG. 7(i) illustrates an exemplary client device characteristics table, in accordance with an embodiment.

FIG. 7(j) illustrates an exemplary user profiles table, in accordance with an embodiment.

FIG. 7(k) illustrates an exemplary environmental characteristics table, in accordance with an embodiment.

FIG. 7(l) illustrates an exemplary logo information table, in accordance with an embodiment.

FIG. 7(m) illustrates an exemplary documents database table, in accordance with an embodiment.

FIG. 8(a) illustrates an exemplary process for starting a client, in accordance with an embodiment.

FIG. 8(b) illustrates an exemplary process for authenticating a client on a system server, in accordance with an embodiment.

FIG. 9 illustrates an exemplary process for capturing visual content and starting client-system server interaction, in accordance with an embodiment.

FIG. 10(a) illustrates an exemplary process of system server operation for processing messages from the client, in accordance with an embodiment.

FIG. 10(b) illustrates an exemplary process for processing natural content, in accordance with an embodiment.

FIG. 10(c) illustrates an exemplary process for extracting embedded information from enhanced natural content, in accordance with an embodiment.

FIG. 10(d) illustrates an exemplary process for retrieving documents from a knowledge base, in accordance with an embodiment.

FIG. 10(e) illustrates an exemplary process for generating natural content from information in machine interpretable format, in accordance with an embodiment.

FIG. 10(f) illustrates an exemplary process for creating documents from a system server, in accordance with an embodiment.

FIG. 11 illustrates an exemplary process for interacting with documents on a client, in accordance with an embodiment.

FIG. 12 illustrates an exemplary process for requesting documents when client 402 is running in system triggered mode, in accordance with an embodiment.

FIG. 13 is a block diagram illustrating an exemplary computer system suitable for authoring and managing multimedia documents, in accordance with an embodiment.

### DETAILED DESCRIPTION OF THE INVENTION

Various embodiments may be implemented in numerous ways, including as a system, a process, an apparatus, or a series of program instructions on a computer-readable medium such as a computer-readable storage medium or a computer network where the program instructions are sent over optical, electrical, electronic, or electromagnetic communication links. In general, the steps of disclosed processes may be performed in an arbitrary order, unless otherwise provided in the claims.

A detailed description of one or more embodiments is provided below along with accompanying figures. The detailed description is provided in connection with such embodiments, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For the purpose of clarity, technical material that is known in the technical fields related to the embodiments has not been described in detail to avoid unnecessarily obscuring the description.

Authoring, management, and retrieval multimedia documents is described, including a method for authoring of multimedia documents, a method for managing of multimedia documents, a method for retrieval of multimedia documents, a system for working with multimedia documents, and the operation of the system. The multimedia documents may be composed from a plurality of multimodal information such as multimedia content sequences, associated metadata, user input, and information derived from knowledge bases. The multimedia content may be captured from sources such as a real-world scene or an electronic multimedia source such as a computer or television display or speakers.

The multimedia content may also be obtained from a prerecorded source such as stored still images, video, or audio, or obtained from another device that is capable of capturing multimedia content. Visual multimedia content used in the multimedia documents may include still pictures, video sequences, or a combination thereof. Audio multimedia content used in the multimedia documents may include speech, music, captured ambient audio, and combinations thereof. Information embedded in the multimedia content is extracted and used in conjunction with the associated metadata, user inputs, and information derived from knowledge bases to compose multimedia documents and provide tools for the management and retrieval of the documents. In addition, providing information services related to the documents is also described. Information services related to the documents provided by the system may include information and optionally features and instructions for the handling of information.

In the present discussion, the terms “multimedia information” and “multimedia content” refer to information comprised of one or more of audio, video, textual, or tactile information. The terms “visual content” and “audio content” refer to multimedia content comprised of video and audio information respectively. “Metadata” refers to information related to a multimedia content that qualifies and describes the content and its origin. “User input” refers to information input by a user of the system. “Knowledge bases” store data, and optionally the structure of the data, metadata related to the data and logic used to interpret the data. In some embodiments, a knowledge base may be substituted with a database in a system, if the information on the structure of data in the database or the logic used to interpret the data in the database is integrated into another component of the system. Similarly, a knowledge base with trivial structures for the data and trivial logic to interpret the knowledge base may be converted to a database. The knowledge bases and databases used by the system may be internal to the system or external to the system. An example of a knowledge base external to the system is the World Wide Web.

Embedded information extracted from the multimedia content, associated metadata, and user inputs are used by the system along with information from knowledge bases to compose multimedia documents. The composed multimedia documents may be stored in the system for later retrieval and use. In its simplest form, the multimedia documents are comprised of the extracted embedded information, offering an alternate representation of the information in the captured content, which can be formatted and rendered as required.

For instance, the textual representation of a page from a newspaper yields to better presentation on devices of various display capabilities rather than the image of the newspaper itself. In a more complex use case, a sequence of images of the cover of a book followed by images of chosen inside pages of a book along with an audio commentary from the user is converted into an electronic booklet by converting the text extracted from the cover of the book into the booklet's title and the text from the inside pages and the audio annotation into the booklet's contents. The documents thus composed may have novel compositions that may or may not necessarily reflect the inherent structure of the captured multimedia information at its source. An example of such a dissociation of the structure of the multimedia document from the structure of the multimedia information at its source is the use of excerpts from a book to compose a new story line. In some embodiments, the documents may also include hyperlinks to other documents or information services. The documents may also optionally include a “table of contents,” which provides a summary of the contents of the documents.

Embedded visual elements derived from visual content by the system include textual elements, formatting attributes of textual elements, graphical elements, information on the layout of the textual and graphical elements in the visual content, and characteristics of different regions of the visual content. Visual elements may either be in machine generated form (e.g., printed text) or manually generated form (e.g., handwritten text). Visual elements may be distributed across multiple still images or video frames of the visual content.

Examples of textual elements derived from visual content include alphabets, numerals, symbols, and pictograms. Examples of formatting attributes of textual elements derived from visual content include fonts used to represent the textual elements, size of the textual elements, color of the textual elements, style of the textual elements (e.g., use of bullets, engraving, embossing) and emphasis (e.g., bold or regular typeset, italics, underlining). Examples of graphical elements derived from visual content include logos, icons, and graphical primitives (e.g., lines, circles, rectangles and other shapes). Examples of layout information of textual and graphical elements derived from visual content include absolute position of the textual and graphical elements, position of the textual and graphical elements relative to each other, and position of the textual and graphical elements relative to the spatial and temporal boundaries of the visual content. Examples of characteristics of regions derived from visual content include size, position, spatial orientation, motion shape, color, and texture of the regions.

Metadata associated with the content used by the system include, but are not limited to, the spatial and temporal dimensions of the content, location of the user, location of the client device, spatial orientation of the user, spatial orientation of the client device, motion of the user, motion of the client device, explicitly specified and learned characteristics of client device (e.g., network address, telephone number and the like), explicitly specified and learned characteristics of the client (e.g., version number of the client and the like), explicitly specified and learned characteristics of the communication network (e.g., measured rate of data transfer, latency and the like), and explicitly specified and learned preferences of the user.

User inputs used by the system may include inputs in audio, visual, textual, or tactile formats. In some embodiments, user inputs may include commands for performing various operations and commands for activating various features integrated into the system.

Knowledge bases used by the system include, but are not limited to, a database of user profiles, a database of client device features and capabilities, a database of users' history of usage, a database of user access privileges for documents in the system, a membership database for various user groups in the system, a database of explicitly specified and learned popularity of documents available in the system, a database of explicitly specified and learned popularity of authors contributing documents to the system, a knowledge base of classifications of documents in the system, a knowledge base of explicitly specified and learned characteristics of the client devices used, a knowledge base of explicitly specified and learned user preferences, a knowledge base of explicitly specified and learned environmental characteristics, and other knowledge bases containing specialized knowledge on various domains such as a database of logos, an electronic thesaurus, a database of the grammar, syntax and semantics of languages, knowledge bases of domain specific ontologism or a geographic information system (GIS). In some embodiments, the system may include a knowledge base of the syntax and semantics of common textual (e.g., telephone number, e-mail address, Internet URL) and graphical entities (e.g., common symbols like “X” for “no,” etc.) that have well defined structures.

Some embodiments may also provide support for the creation and management of groups of users of the system. This enables easy sharing of documents and other information among groups of users. These groups may either be created by the users as in the case of a list of friends or by the system as in the case of groups of common interest. Users or the operators of the system can add, delete, and modify groups created by them by adding and/or deleting users from the groups. Multimedia documents in the system may also be owned, authored, and modified jointly by a group of users. In some embodiments, multimedia documents may also be authored anonymously.

Some embodiments may also support classification of the documents through explicit specification by users of the system or automatic classification by the system based on analysis of the contents of documents. This enables the organization of the documents into folders similar to the folder hierarchy in computer file systems. The classification of the multimedia documents and the organization of users into groups may also serve as metadata for the information stored in the system.

Some embodiments may also include authentication, authorization, and accounting (AAA) functionality. Such embodiments may require users to authenticate themselves to the system to use its features. Further, the system may authorize various access controls for multimedia documents composed and stored in the system. Users or operators of the system can restrict read, write, delete, or modification access rights to the documents authored by the users for other users of the system. This enables the sharing of documents among users of the system in a controlled fashion. In addition, the system may also enable sharing of the documents with others who are not active users of the system, for example through the Internet. This sharing may be achieved through a Web site, facsimile, e-mail, SMS, MMS, or other communication media.

Accounting features optionally integrated into the system may enable monitoring of the usage of the system by the users for performance monitoring, accounting, and billing purposes. Users may be charged for usage of the system through subscription based and/or pay-as-you-go or transactional billing schemes. Some embodiments may also use digital rights management features for the management of the access and use rights for the documents and other aspects of the system such as groups and classifications. Further, the authentication, authorization, and accounting features also enable commercial transaction of documents.

Besides, storage, retrieval, and management of the documents, users of the system may also access information services related to the stored documents and their contents. For instance, the address in the text extracted from a business card stored by the system may be used to generate maps or driving directions. Contexts for providing the information services are constituted from the contents of the documents, metadata associated with the content, metadata generated by the user and/or client's current state, user inputs and information from knowledge bases. Further, the systems may also enable users to store the links to information services and/or the information associated with information services along with the document. This enables the user to instantly access the information services and/or information services at a later time even if the associated documents are not available or replaced by other information services.

The term “information service” refers to a user experience provided by the system that may include (1) the logic to present the user experience, (2) multimedia content and (3) related user interfaces. Information services may enable the delivery, creation, deletion, modification, classification, storing, sharing, communication, and interassociation of information. Further, information services may also enable the delivery, creation, deletion, modification, classification, storing, sharing, communication, and interassociation of other information services. Furthermore, information services may also enable the control of other physical and information systems in physical or computer environments. As used herein, the term “physical systems” may refer to objects, systems, and mechanisms that may have a material or tangible physical form. Examples of physical systems include a television, a robot, or a garage door opener.

As used herein, the term “information systems” may refer to processes, systems, and mechanisms that process information. Examples of information systems include a software algorithm or a knowledge base. Furthermore, information services may enable the execution of financial transactions. Information services may contain one or more data/media types such as text, audio, still images and video. Further, information services may include instructions for one or more processes, such as delivery of information, management of information, sharing of information, communication of information, acquisition of user and sensor inputs, processing of user and sensor inputs and control of other physical and information systems. Furthermore, information services may include instructions for one or more processes, such as delivery of information services, management of information services, sharing of information services and communication of information services. Information services may be provided from sources internal to the system or external to the system. Sources external to the system may include the Internet. Examples of Internet services include World Wide Web, e-mail, and the like. An exemplary information service may comprise of a World Wide Web page that includes both information and instructions for presenting the information. Examples of more complex information services include Web search, e-commerce, Web services using RSS, SOAP, REST and the like, comparison shopping, streaming video, computer games and the like. In another example, an information service may provide a modified version of the information or content from a World Wide Web resource or URL.

Information services are associated with documents through interpretation of context constituents associated with the documents. Context constituents associated with documents may include: 1) the contents of the documents, 2) embedded elements derived from contents of the documents, 3) metadata associated with the documents, 4) user inputs associated with the documents, and 5) relevant knowledge derived from knowledge bases. Contexts with varying degrees of relevance to the documents are generated from context constituents through various permutations and combinations of the context constituents. Information services identified as relevant to the contexts associated with a document form the available set of information services identified as relevant to the document.

As used herein, the term “natural media format” may refer to content in formats suitable for reproduction on output components or suitable for capture through input components. The term “operators” refers to a person on business entity that operates a system as described below.

System Architecture

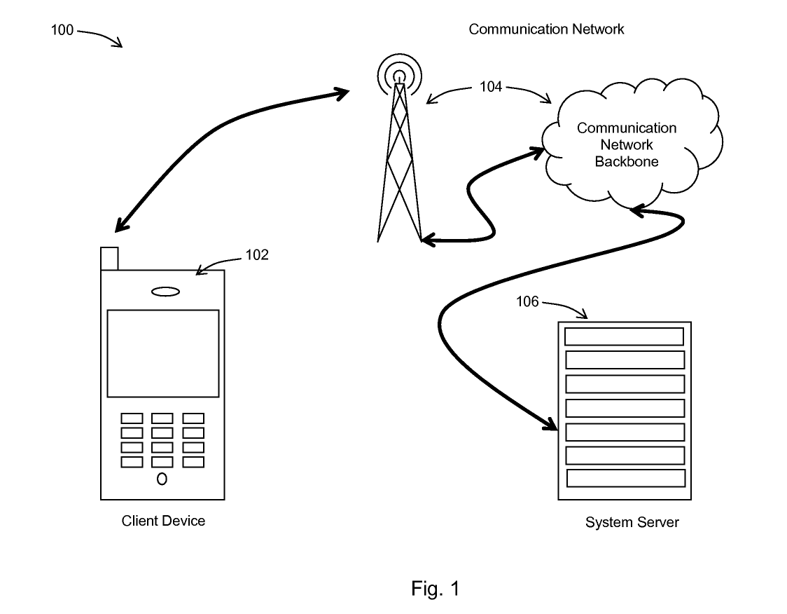

FIG. 1 illustrates an exemplary system, in accordance with an embodiment. Here, system 100 includes client device 102, communication network 104, and system server 106.

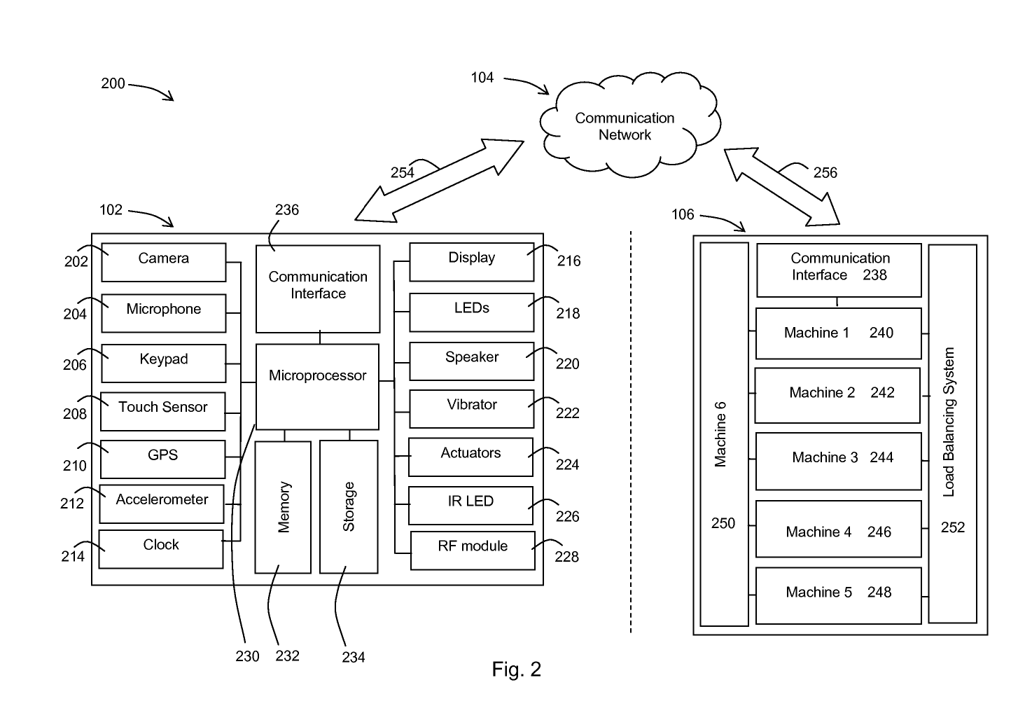

FIG. 2 illustrates an alternative view of an exemplary system, in accordance with an embodiment. System 200 illustrates the hardware components of the exemplary embodiment (e.g., client device 102, communication network 104, and system server 106). Here, client device 102 communicates with system server 106 over communication network 104. In some embodiments, client device 102 may include camera 202, microphone 204, keypad 206, touch sensor 208, global positioning system (GPS) module 210, accelerometer 212, clock 214, display 216, visual indicators (e.g., LEDs) and/or a projective display (e.g., laser projection display systems) 218, speaker 220, vibrator 222, actuators 224, IR LED 226, radio frequency (RF) module (i.e., for RF sensing and transmission) 228, microprocessor 230, memory 232, storage 234, and communication interface 236. System server 106 may include communication interface 238, machines 240-250, and load balancing subsystem 252. Data flows 254-256 are transferred between client device 102 and system server 106 through communication network 104.

Client device 102 includes camera 202, which is comprised of a visual sensor and appropriate optical components. The visual sensor may be implemented using a charge coupled device (CCD), a complementary metal oxide semiconductor (CMOS) image sensor or other devices that provide similar functionality. The camera 202 is also equipped with appropriate optical components to enable the capture of visual content. Optical components such as lenses may be used to implement features such as zoom, variable focus, macro-mode, auto focus, and aberration-compensation.

Client device 102 may also include a visual output component (e.g., LCD panel display) 216, visual indicators (e.g., LEDs) and/or a projective display (e.g., laser projection display systems) 218, audio output components (e.g., speaker 220), audio input components (e.g., microphone 204), tactile input components (e.g., keypad 206, keyboard (not shown), touch sensor 208, and others), tactile output components (e.g., vibrator 222, mechanical actuators 224, and others) and environmental control components (e.g., Infrared LED 226, radio-frequency (RF) transceiver 228, vibrator 222, actuators 224). Client device 102 may also include location measurement components (e.g., GPS receiver 210), spatial orientation and motion measurement components (e.g., accelerometers 212, gyroscope), and time measurement components (e.g., clock 214).

Examples of client device 102 include communication equipment (e.g., cellular telephones), business productivity gadgets (e.g., personal digital assistants (PDA)), and consumer electronics devices (e.g., digital camera and portable game devices or television remote control). In some embodiments, components, features, and functionality of client device 102 may be integrated into a single physical object or device such as a camera phone.

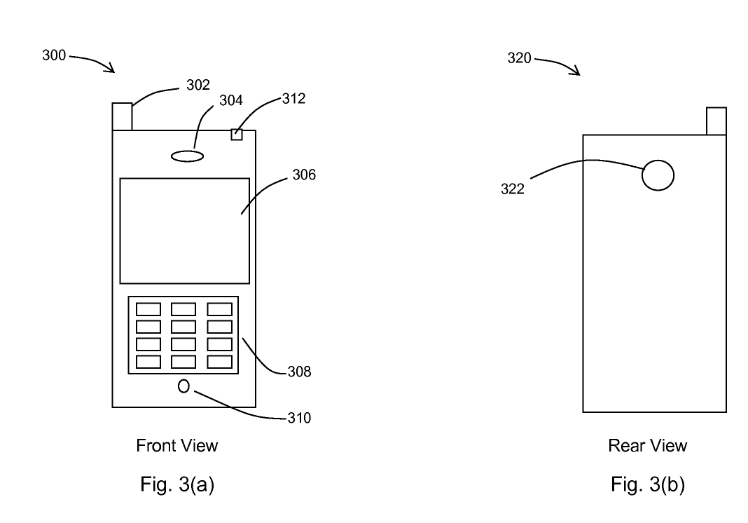

FIG. 3(a) illustrates a front view of an exemplary client device, in accordance with an embodiment. In some embodiments, client device 300 may be implemented as client device 102. Here, the front view of client device 300 includes communication antenna 302, speaker 304, display 306, keypad 308, microphone 310, and a visual indicator such as a light emitting diode (LED) and/or a projective display 312. In some embodiments, display 306 may be implemented using a liquid crystal display (LCD), plasma display, cathode ray tube (CRT) or organic LEDs (OLEDs).

FIG. 3(b) illustrates a rear view of an exemplary client device, in accordance with an embodiment. Here, rear view 320 illustrates the integration of camera 322 into client device 102. In some embodiments, a camera sensor and optics may be implemented such that a user may operate camera 322 using controls on the front of client device 102.

In some embodiments, client device 102 is a single physical device (e.g., a wireless camera phone). In other embodiments, client device 102 may be implemented in a distributed configuration across multiple physical devices. In such embodiments, the components of client device 102 described above may be integrated with other physical devices that are not part of client device 102. Examples of physical devices into which components of client device 102 may be integrated include cellular phone, digital camera, point-of-sale (POS) terminal, Web cam, PC keyboard, television set, computer monitor, and the like.

Components (i.e., physical, logical, and virtual components and processes) of client device 102 distributed across multiple physical devices are configured to use wired or wireless communication connections among them to work in a unified manner. In some embodiments, client device 102 may be implemented with a personal mobile gateway for connection to a wireless wide area network (WAN), a digital camera for capturing visual content and a cellular phone for control and display of documents and information service with these components communicating with each other over a wireless personal area network such as Bluetooth™ or a LAN technology such as Wi-Fi (i.e., IEEE 802.11x).

In some other embodiments, components of client device 102 are integrated into a television remote control or cellular phone while a television is used as the visual output device. In still other embodiments, a collection of wearable computing components, sensors and output devices (e.g., display equipped eye glasses, direct scan retinal displays, sensor equipped gloves, and the like) communicating with each other and to a long distance radio communication transceiver over a wireless communication network constitutes client device 102. In other embodiments, projective display 218 projects the visual information to be presented on to the environment and surrounding objects using light sources (e.g., lasers), instead of displaying it on display panel 216 integrated into the client device.

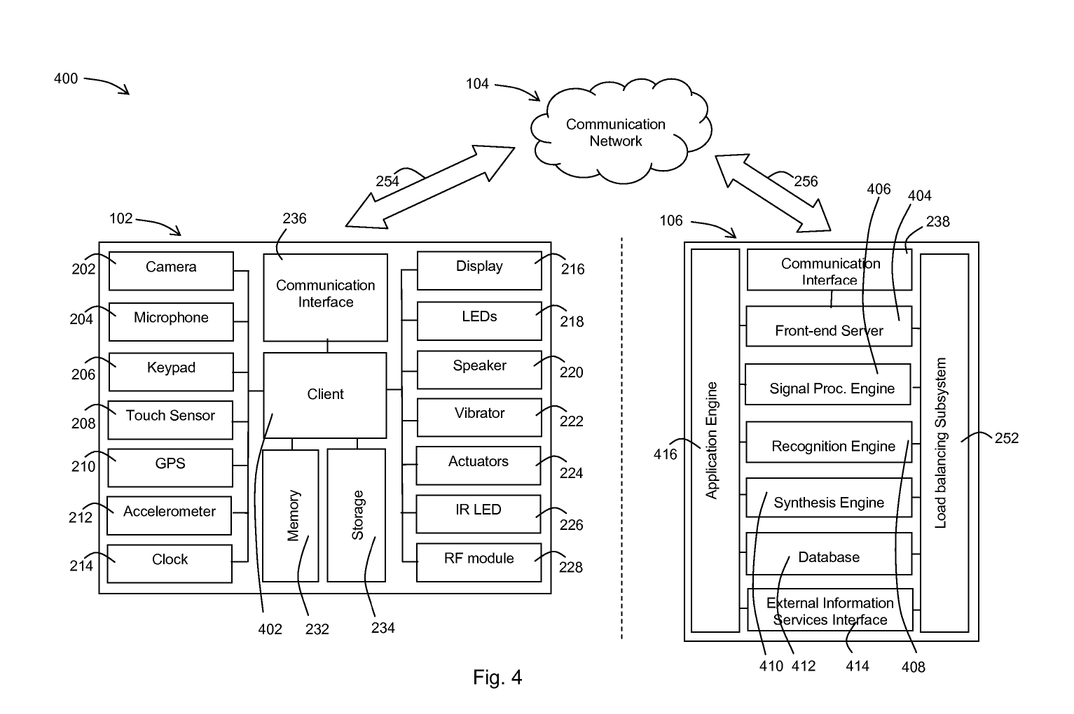

FIG. 4 illustrates another alternative view of an exemplary system, in accordance with an embodiment. Here, system 400 includes client device 102, communication network 104, and system server 106. In some embodiments, client device 102 may include microphone 204, keypad 206, touch sensor 208, GPS module 210, accelerometer 212, clock 214, display 216, visual indicator and/or projective display 218, speaker 220, vibrator 222, actuators 224, IR LED 226, RF module 228, memory 232, storage 234, communication interface 236, and client 402. In this exemplary embodiment, system server 106 may include communication interface 238, load balancing sub-system 252, front end-server 404, signal processing engine 406, recognition engine 408, synthesis engine 410, database 412, external information services interface 414, and application engine 416.

In some embodiments, client 402 may be implemented as a state machine that accepts visual, aural, and tactile input information along with the location, spatial orientation, motion, and time from client device components. Using these inputs, client 402 analyzes, determines a course of action and performs one or more of the following: communicate with system server 106, present output information through visual, aural, and tactile output components or control the environment of client device 102 using control components (e.g., IR LED 226, RF module 228, visual indicator/projective display 218, vibrator 222 and actuators 224). Client 402 interacts with the user and the physical environment of client device 102 using the input, output, and sensory components integrated into client device 102.

Information exchanged and actions performed through these input, output, and sensory components by the user and client device environment contribute to the user interface of client 402. Other functionality provided by a client user interface include the presentation of documents retrieved from system server 106, editing, and authoring of documents, interassociation of documents, sharing of documents, request of documents from specific classifications, classification of documents, communication of documents, management of user groups, presentation of various menu options for executing commands, and the presentation of a help system for explaining system features to the users.

The client user interface may also feature functionality similar to the enumeration listed above related to documents, for information services related to the documents. In some embodiments, client 402 may use the environmental control components integrated into client device 102 to control other physical systems in the physical environment of the client device 102 through infrared, RF or mechanical signals.

In some embodiments, a client user interface may include a viewfinder for live rendering of visual content captured by a visual sensor integrated into client device (e.g., camera 202) or visual content retrieved from storage 234. In some embodiments, an augmented view of visual content may be presented by modifying an attribute (e.g., hue, saturation, contrast, or brightness of a region, color, font, formatting, emphasis, style, and others) of the visual content. The choice of attributes of visual content that are modified may be based on user preferences or automatically determined by system 1 00. In other embodiments, text, icons, or graphical content is embedded in the visual content to present an augmented view of the visual content.

In some embodiments, client 402 may be implemented as a software application for a software platform (e.g., Java 2 Micro Edition (J2ME), S60, Windows Mobile, or Symbian OS™) on client device 102. In this case, client device 102 may use a programmable microprocessor 230 with associated memory 232 and storage 234 to save and execute software and its associated data. In other embodiments, client 402 may also be implemented in hardware or firmware for a customized or reconfigurable electronic machine. In some embodiments, client 402 may reside on client device 102 or may be downloaded on to client device 102 from system server 106. In the latter example, client 402 may be upgraded or modified remotely. In some embodiments, client 402 may also interact with and modify other elements (i.e., applications or stored data) of client device 102.

In some embodiments, client 402 may be used to create and present documents and information services. In other embodiments, client 402 may be used to create and present documents and information services through other logic (e.g., software applications) integrated into client device 102. For example, documents and information services may be created or presented through a web browser integrated into client device 102. In such embodiments, client device 102 may not incorporate components for capturing multimedia information. Instead, multimedia content may be uploaded from storage 234 integrated into the system. Storage 234 may be integrated with either client device 102 or system server 106.

In some other embodiments, the functionality of client 402 may be integrated in its entirety into other logic present in client device 102 such as a Web browser. In some embodiments where client device 102 is implemented as a distributed device whose components are distributed over a plurality of physical devices, components of client 402 may also be distributed over the plurality of physical devices comprising client device 102.

In some embodiments, a user may be presented visual content through display 216. Visual content for presentation may be encoded using appropriate source coding algorithms (e.g., Joint Picture Experts Group (JPEG), Graphics Interchange Format (GIF), Motion Picture Experts Group (MPEG), H.26x, Scalable Vector Graphics, Flash™, and the like). The encoded visual content is decoded before presentation on display 216. In other embodiments, visual information may also be presented through visual indicators and/or projective display 218. Display 216 may provide a graphical user interface while visual indicator 218 may provide visual indications of other forms of information (e.g., providing a flashing light indicator when new documents are available on the client for presentation to the user). The graphical user interface may be generated by client 402 using graphical widget primitives provided by software environments, such as those described above, in conjunction with custom graphics and bitmaps to provide a particular look and feel.

In some embodiments, audio content may be presented using speaker 220 and tactile information may be presented using vibrator 222. In some embodiments, audio content may be encoded using a source coding algorithm such as RT-CELP or AMR for cellular communication. Encoded audio content is decoded prior to being presented through speaker 220. Microphone 204, camera 202, and keypad 206 handle audio, visual, and tactile inputs, respectively. Audio content captured by microphone 204 may be encoded using a source coding algorithm by microprocessor 230.

In some embodiments, camera optics (not shown) may be implemented to focus an image on the camera sensor. Further, the camera optics may provide zoom and/or macro functionality. Focusing, zooming, and macro operations may be achieved by moving the optical surfaces of camera optics either manually or automatically. Manual focus, zooming, and macro operations may be performed based on the visual content displayed on the client user interface using appropriate controls provided on the client user interface or client device 102. Automatic focus, zooming, and macro operations may be performed by logic that measures features (e.g., edges) of captured visual content and controls the optical surfaces of the camera optics appropriately to optimize the measured value of such features. The logic for performing such optical operations may be embedded in client 402 or embedded into the optical system.

Keypad 206 may be implemented as a number-oriented keypad or a full alphanumeric “qwerty” keypad. In some embodiments employing a camera phone, keypad 206 may be a numbers-only keypad, which provides a compact physical structure for the camera phone. The signal generated by the closing of the switches integrated into the keypad keys is translated into an ASCII, Unicode, or other such textual representations by the software environment. Thus, the operations of the keypad keys are translated into a textual data stream for the client 402 by the software environment. The clock 214 integrated into client device 102 provides the time and may be synchronized with the local or Universal time manually or automatically by the communication network 104. The location of client device 102 may be derived from an embedded GPS receiver 210 that uses the time difference between signals from the GPS satellites to triangulate the location of the client device. In other embodiments, the location of client device 102 may be determined using network assisted technologies such as Assisted Global Positioning System (AGPS) and Time Difference of Arrival (TDOA).

In some embodiments, client 402 may be implemented as software residing on a single-piece integrated device such as a camera phone. FIGS. 3(a) and 3(b) illustrate the external features of a wireless camera phone. Such a camera phone is a portable, programmable computer equipped with input, output, sensory, communication, and environmental control components such as those discussed above.

The programmable computer may be implemented using a microprocessor 230 that executes software logic stored in local storage 234 using the memory 232 for temporary storage. Microprocessor 230 may be implemented using various technologies such as ARM or xScale. The storage may be implemented using media such as flash memory or a hard disk while memory may be implemented using DRAM or SRAM.

Further, a software environment built into client device 102 enables the installation, execution, and presentation of software applications. Software environments may include an operating system to manage system resources (e.g., memory 232, storage 234, microprocessor 230, and the like), a middleware stack that provides libraries of commonly used functions and data, and a user interface through which a user may launch and interact with software applications. Examples of such software environments include Nokia™ S60™, Palm™, Microsoft™ Windows Mobile™, and Java J2ME™ These environments use SymbianOS™, PalmOS™, Windows CE™ and other operating systems in conjunction with other middleware and user interface software. As an example, client 402 may be implemented using J2ME as the software environment.

In some embodiments, system server 106 may be implemented in a datacenter equipped with appropriate power supply and communication support systems. In addition, more than one instance of system server 106 may be implemented in a data center or the multiple instances of system server 106 distributed across multiple datacenters to ensure reliability and fault tolerance.

In other embodiments, distribution of functionality between client 402 and system server 106 may vary. Some components or functionality of client 402 may be realized on system server 106 and some components or functionality of system server 106 may be realized on client 402. For example, recognition engine 408 and synthesis engine 410 may be integrated into client 402. In such embodiments, communication network 104 may be realized as a computer bus (e.g., PCI) or cable connection (e.g., Firewire). In another example, recognition engine 408 may be implemented partly on client 402 and partly on system server 106. As another example, a database may be used by client 402 to cache information for communication with system server 106.

In some embodiments, system 100 may reside entirely on client device 102. In still other embodiments, a user's personal data storage equipment (e.g., personal computer) may be used to store documents or host system server 106. The documents can then be stored either in an independent database on the personal computer or as e-mail or notes in a personal information management (PIM) application such as Microsoft Outlook on the personal computer.

The storage of the multimedia documents as e-mail enables convenient access to the documents both from the personal computer and from other devices. In yet another embodiment, the personal computer can be used to store the documents while the computation functions of system server 106 can be provided by a server resident remotely in a datacenter.

In other embodiments, system server 106 may be implemented as a distributed peer-to-peer system residing on users' personal computing equipment (e.g., personal computers, laptops, personal digital assistants, and the like) or wearable computing equipment. The distribution of functions between client 402 and system server 106 may also be varied over the course of operation (i.e., over time). Components of system server 106 may be implemented as software, custom hardware logic, firmware on reconfigurable hardware logic, or a combination thereof.

In some embodiments, client 402 and system server 106 may be implemented on programmable infrastructure that enables the download or updating of new features, personalization based on criteria including user preferences, adaptation for device capabilities, and custom branding. Components of system server 106 are described in greater detail below. In some embodiments, system server 106 may include more than one of each of the components described below.

In some embodiments, system server 106 may include a load balancing subsystem 252, which monitors the computational load on the components and distributes various tasks among the components in order to improve server component utilization and responsiveness. The load balancing system 252 may be implemented using custom software logic, Web switches, or clustering software.

In some embodiments, front-end server 404 acts as an interface between communication network 104 and system server 106. Front-end server 404 ensures the integrity of the data in the messages received from client device 102 and forwards the messages to application engine 416. Unauthorized accesses to system server 106 or corrupted messages are dropped. Response messages generated by application engine 416 may also be routed through front-end server 404 to client 402. In other embodiments, front-end server 404 may be implemented differently other than as described above.

In some embodiments, signal processing engine 406 performs enhancement and modification of multimedia data in natural media formats such as audio, still images, and video. The enhanced and modified multimedia data is used by recognition engine 408. Since the signal processing operations performed may be unique to each media type, signal processing engine 406 may include one or more independent software modules each of which may be used to enhance or modify a specific media type. Examples of processing functions performed by signal processing engine 406 modules are described below. Signal processing engine 406 and its various embodiments may be varied in structure, function, and implementation beyond the description provided. Signal processing engine 406 is not limited to the descriptions provided.

In some embodiments, signal processing engine 406 may include an audio enhancement engine module (not shown). An audio enhancement engine module processes signals to enhance characteristics of audio content such as the spectral envelope, frequency, pitch, tone, balance, noise, and other audio characteristics. Audio captured from a natural environment often includes environmental noise. Source and channel codecs used to encode the audio add further noise to the audio. Such noise are reduced and removed based on analysis of the audio content and models of the noise. The spectral characteristics of the audio may be modified using cascaded low pass and high pass filters for changing the spectral envelope, pitch and the tone of the audio.

Signal processing engine 406 may also include an audio transformation engine module (not shown) that transforms sampling rates, sample precision, channel count, and source coding formats of audio content. The audio transformation engine module may be used to convert the audio information between different source coding formats used by different audio systems. Further, the audio transformation engine module may provide high level transformations (e.g., modifying speech content to sound as though spoken by a different speaker or a synthetic character) or modifying music to substitute musical instruments (e.g., replace a piano with a guitar, and the like). These higher-level transformations may use speech, music, psychoacoustic and other models to interpret audio content and generate modified versions using techniques such as those described above.

Signal processing engine 406, in some embodiments, may include a visual content enhancement engine module. The visual content enhancement module enhances characteristics of visual content (e.g., brightness, contrast, focus, saturation, and gamma) and corrects aberrations (e.g., color and camera lens aberrations). Brightness, contrast, saturation, and gamma correction may be performed by using additive filters or histogram processing. Focus correction may be implemented using high-pass Wiener filters and blind-deconvolution techniques. Aberrations produced by camera optics such as barrel distortion may be resolved using two dimensional (2D) space variant filters. Aberrations induced by visual sensors may be corrected by modeling aberrations induced by the visual sensors and inverse filtering the distorted content.

In other embodiments, signal processing engine 406 may include a visual transformation engine module (not shown). A visual transformation engine module provides low-level visual content transformations such as color space conversions, pixel depth modification, clipping, cropping, resizing, rotation, spatial resampling, and video frame rate conversion. Other functions that may be performed by a visual transformation engine module include affine and perspective transformations (e.g., resizing, rotation), which use matrix arithmetic with the matrix representation of the affine or perspective transformation. The visual transformation engine module may also perform transformations that use automatic detection and correction of spatial orientation of content. Another visual transformation that may be performed by the visual transformation engine module is “stitching” of multiple still images into larger images or higher resolution images. Stitching enables the extraction of visual elements that span multiple images/frames.

In some embodiments, a recognition engine 408 that analyzes information in natural media formats (e.g., audio, still images, video, and others) to derive information in machine interpretable form is included. Recognition engine 408 may be implemented using customized software, hardware, or firmware. Recognition engine 408 and its various embodiments may be varied in structure, function, and implementation beyond the descriptions provided. Further, recognition engine 408 is not limited to the descriptions provided.

In some embodiments, recognition engine 408 may include a text recognition engine module (not shown), which extracts information on text and symbols embedded in visual content. The extracted information may include text and symbols and formatting attributes (e.g., font, color, size, style, and emphasis), layout information (e.g., organization into a hierarchy of characters, words, lines, and paragraphs, positions relative to other text and boundaries). A text recognition engine module may use image binarization, identification and extraction of features (e.g., text regions), pattern recognition (e.g., using Bayesian logic or neural networks) and a database of characters and words in a language to generate textual information from the visual content. In some embodiments, more than one text recognition engine may be used (i.e., in parallel) and recognition results may be aggregated using a voting or weighting mechanism to improve recognition accuracy.

In some embodiments, recognition engine 408 may include a generalized visual recognition engine module configured to extract information such as the shape, texture, color, size, position, and motion of any logos and icons embedded in visual content. The generalized visual recognition engine module (not shown) may also be configured to extract information regarding the shape, texture, color, size, position, and motion of different regions in the visual content. Visual content may be segmented or isolated into regions using techniques such as edge detection and morphology. Characteristics of the regions may be extracted using localized feature extraction algorithms.

Recognition engine 408 may also include a voice recognition engine module (not shown). A voice recognition engine module may be implemented to evaluate the probability of a voice in audio content belonging to a particular speaker. Analysis of audio characteristics (e.g., spectrum frequencies, amplitude, modulation, and the like) and psychoacoustic models of speech generation may be used to determine the probability.

In some embodiments, recognition engine 408 may also include a speech recognition engine module (not shown) that converts spoken audio content to a textual representation. Speech recognition may be implemented by segmenting speech into phonemes, which are compared against dictionaries of phonetic sequences for words in a language. In other embodiments, the speech recognition engine module may be implemented differently.

In other embodiments, recognition engine 408 may include a music recognition engine module (not shown) that is configured to evaluate the probability of a musical score in audio content being identical to another musical score (e.g., a song prerecorded and stored in a database or accessible through a music knowledge base). Music recognition involves generation of a signature for segments of music based on spectral properties. Music recognition may also involve knowledge of music generation (i.e., construction of music) and comparison of a signature for a given musical score against signatures of other musical scores (e.g., stored as data in a library or database).

In still further embodiments, recognition engine 408 may include a generalized audio recognition engine module (not shown). A generalized audio recognition engine module analyzes audio content and generates parameters that define audio content based on spectral and temporal characteristics, such as those described above.

In some embodiments, synthesis engine 410 generates information in natural media formats (e.g., audio, still images, and video) from information in machine-interpretable formats. Synthesis engine 410 and its various embodiments may be varied in structure, function, and implementation beyond the description provided. Synthesis engine 410 is not limited to the descriptions provided.

Synthesis engine 410 may include a graphics engine module or an image-based rendering engine module configured to render synthetic visual scenes from machine-interpretable definitions of visual scenes.

Graphical content generated by a graphics engine module may include simple graphical marks (e.g., primitive geometric figures, icon bitmaps, logo bitmaps, etc.) and complete 2D and 3D graphical objects. Graphical content generated by a graphics engine module may be presented as standalone content on a client user interface or integrated with captured visual content to form an augmented reality representation (e.g., images overlaid on other images). In some embodiments, graphics engine module may generate graphics of different spatial and color space resolutions and dimensions to suite the presentation capabilities of client 402. Further, the functionality of the graphics engine module may also be distributed between client 402 and system server 106 to distribute the processing required to generate the graphics content, to make use of any special graphics processing capabilities available on client devices or to reduce the volume of data exchanged between client 402 and system server 106.

In some embodiments, synthesis engine 410 may include an image-based rendering (IBR) engine module (not shown). As an example, an IBR engine may be configured to render synthetic visual scenes by interpolating and extrapolating still images and video to yield volumetric pixel data. An IBR engine module may be used to generate photorealistic renderings for seamless incorporation into visual content for realistic augmentation of the visual content.

In some embodiments, synthesis engine 410 may include a speech synthesis engine module (not shown) that generates speech from text, outputting the speech in a natural audio format. Speech synthesis engine modules may also support a number of voices or personalities that are parameterized based on the pitch, intonations, and other audio and vocal characteristics of the synthesized speech.

In some embodiments, synthesis engine 410 may include a music synthesis engine module (not shown), which is configured to generate musical scores in a natural audio format from textual or musical score input data. For example, MIDI and MPEG-4 Structured Audio synthesizers may be used to generate music from machine-interpretable musical scores.

In some embodiments, database 412 is included in system server 106. In some embodiments, database 412 is implemented as an external component and interfaced to system server 106. Database 412 may be configured to store data for system management and operation. Database 412 may also be configured to store data used to generate and provide documents and information services. Knowledge bases that are internal to system 100 may be part of database 412. In some embodiments, the databases themselves may be implemented using a relational database management system (RDBMS). Other embodiments may use object-oriented databases (OODB), extensible markup language database (XMLDB), lightweight directory access protocol (LDAP), and/or other systems.

In some embodiments, external information services interface 414 enables application engine 416 to access information services provided by external sources. External information services may include communication services and information services derived from databases. In some embodiments, externally-sourced communication services may include, but are not limited to, voice telephone calls, video telephony calls, SMS, instant messaging, e-mails and discussion boards. Externally sourced database derived information services may include, but are not limited to, information services that may be found on the Internet (e.g., Web search, Web storefronts, news feeds and specialized database services such as Lexis-Nexis and others).

Application engine 416 executes logic that interprets commands and messages from client 402 and generates an appropriate response by orchestrating other components in system server 106. Application engine 416 may be configured to interpret messages received from client 402, compose response messages to send to client 402, implement business logic, interpret commands in user inputs, forward natural media content to signal processing engine 406 for processing, forward natural media content to recognition engine 408 for conversion into machine interpretable form, forward information in machine interpretable form to synthesis engine 410 for conversion to natural media formats, store, retrieve and modify information from databases, access documents and information services from sources external to system server 106, establish communication service sessions, and determine actions for orchestrating the above-described features and components.

Application engine 416 may be configured to use signal processing engine 406 to enhance information in natural media format. Application engine 416 may also be configured to use recognition engine 408 to convert information in natural media formats to machine interpretable form, generate contexts from available context constituents, and identify documents and information services from information stored in databases 412 integrated into the system server 106 and from external information services. Application engine 416 may also convert user inputs in natural media formats to machine interpretable form using recognition engine 408.

For instance, user input in audio form may be converted to textual form using the speech recognition module integrated into the recognition engine 408 for processing spoken commands from the user. Application engine 416 may also be configured to convert information services from machine readable form to natural media formats using synthesis engine 41 0. Further, application engine 416 may be configured to generate and communicate response messages to client 402 over communication network 104. Additionally, application engine 416 may be configured to update client logic over communication network 104. Application engine 416 may be implemented using programming languages such as Java or C++.

Client device 102 communicates with system server 106 over communication network 104. Communication network 104 may be implemented using a wired network technology such as Ethernet, cable television network (DOCSIS), phone network (xDSL) or fiber optic cables. Communication network 104 may also use wireless network technologies such as cable replacement technologies such as Wireless IEEE 1394, personal area network technologies such as Bluetooth™ Local Area Network (LAN) technologies such as IEEE 802.11x, Wide Area Network (WAN) technologies such as GSM, GPRS, EDGE, UMTS, CDMA One, CDMA 1x, CDMA 1x EV-DO, CDMA 1x EV-DV, IEEE 802.x networks, or their evolutions. Communication network 104 may also be implemented as an aggregation of one or more wired or wireless network technologies.

In some embodiments, client 402 and system server 106 may use various data communication protocols e.g., HTTP, ASN.1 BER, .Net, XML, XML-RPC, SOAP, web services, and others. In some embodiments, a system specific protocol may be layered over a lower level data communication protocol (e.g., HTTP, TCP/IP, UDP/IP, or others). In some embodiments, data communication between client 402 and system server 106 may be implemented using SMS, WAP push or a TCP/UDP session initiated by system server 106.

In some embodiments, client device 102 communicates over a cellular network to a cellular base station, which in turn is connected to a datacenter housing system server 106 through the Internet. Data communication may be implemented using cellular communication standards such as circuit switched cellular networks, generalized packet radio service (GPRS), UMTS or CDMA2000 1x. The communication link from the base station to the datacenter may be implemented using heterogeneous wireless and wired networks.

As an example, system server 106 may connect to an Internet backbone termination in a datacenter using an Ethernet connection. This heterogeneous data path from client device 102 to the system server 106 may be unified through use of the TCP/IP protocol across all components. Hence, in some embodiments, data communication between client device 102 and the system server 106 may use a system specific protocol overlaid on top of the TCP/IP protocol, which is supported by client device 102, the communication network and the system server 106. In other embodiments, where data is transmitted more asynchronously, a protocol such as UDP/IP may be used.

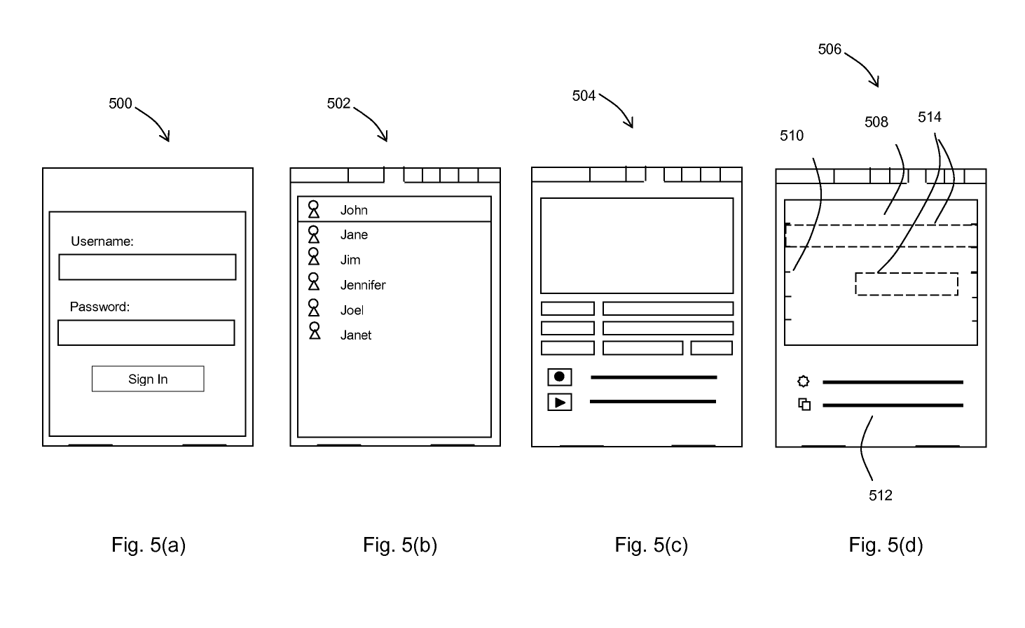

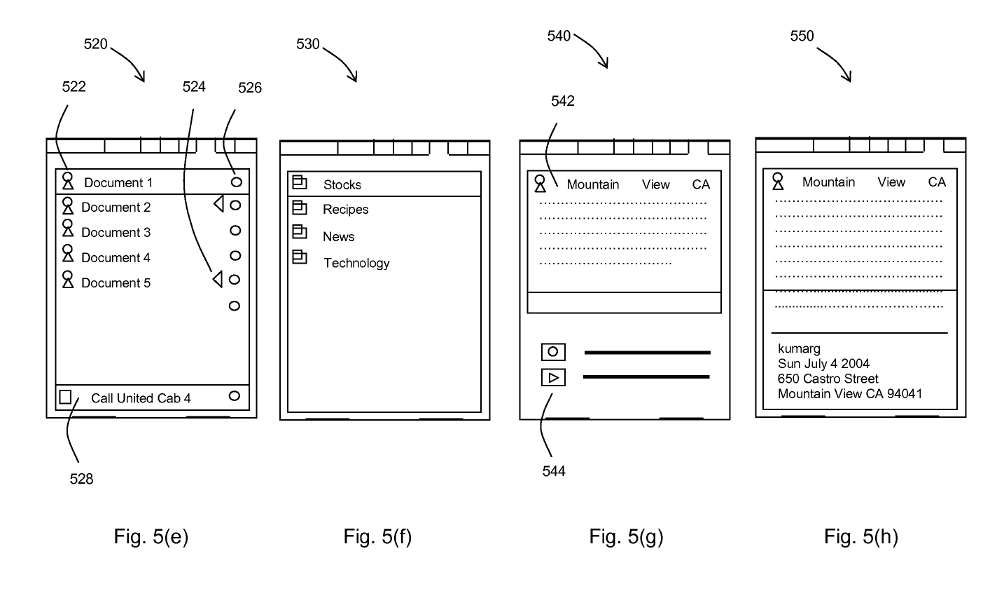

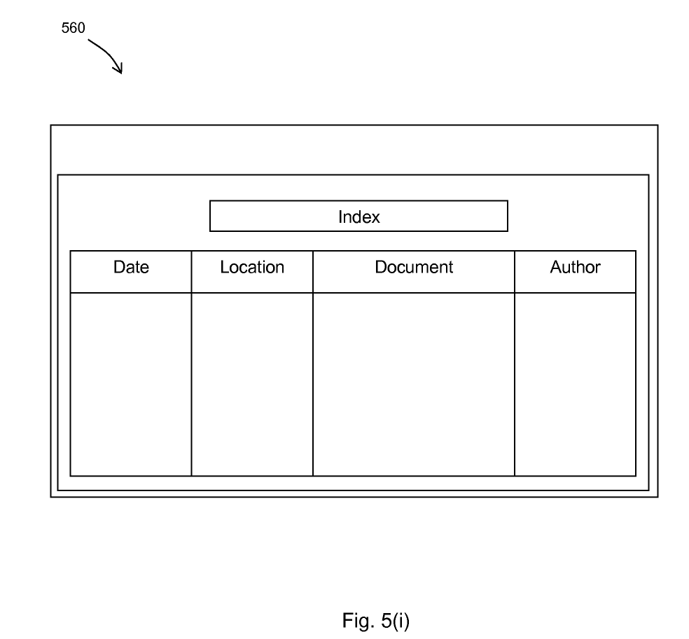

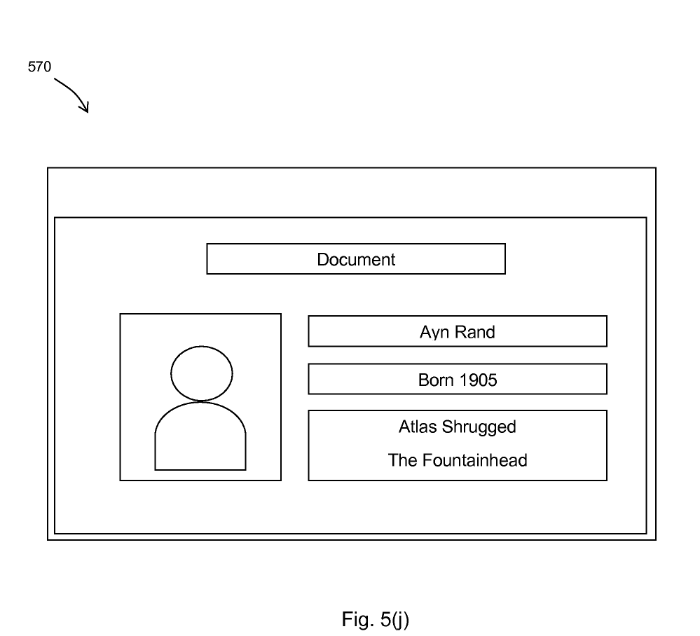

In some embodiments, client 402 generates and presents visual components of a user interface on display 216. Visual components of a user interface may be organized into the login, settings, author, home, index, folder, and content views as shown in the FIGS. 5(a)-5(h). User interface views shown in FIGS. 5(a)-5(h) may also include commands on popup menus that perform various operations presented on a user interface.

FIG. 5(a) illustrates an exemplary login view of the client user interface, in accordance with an embodiment. Here, login view 500 enables a user to enter a textual user identifier and password. In other embodiments, different login techniques may be used.

FIG. 5(b) illustrates an exemplary settings view of the client user interface, in accordance with an embodiment. Here, settings view 502 provides an example of a user interface that may be used to configure various settings including user-definable parameters on client 402 (e.g., user groups, user preferences, and the like).

FIG. 5(c) illustrates an exemplary author view of the client user interface, in accordance with an embodiment. Here, author view 504 presents a user interface that a user may use to modify, alter, add, delete, or perform other document authoring operations on client 402. In some embodiments, author view 504 enables a user to create new documents or set access privileges for documents.

FIG. 5(d) illustrates an exemplary home view of the client user interface, in accordance with an embodiment. Here, home view 506 may display visual content captured by the camera 202 or visual content retrieved from storage 234 on viewfinder 508. Home view 506 may also include reference marks 510, which may be used to aid users in capturing live visual content (i.e., evaluation of size, resolution, orientation, and other characteristics of the content being captured).

By aligning text in viewfinder 508 to the reference marks 510 through rotation and motion of the camera relative to the scene being imaged and by ensuring the text is at least as tall as the vertical gap between the reference marks, users may ensure capture of visual content of text for optimal functioning of the system. Home view 506 may also include textual and graphical indicators 512 of characteristics of visual content (e.g., brightness, focus, rate of camera motion, rate of motion of objects in the visual content and others). Home view 506 may also incorporate controls for capture of audio information.

FIG. 5(e) illustrates an exemplary index view of the client user interface, in accordance with an embodiment. Here, index view 520 displays a list of documents and information services. Further, index view 520 also presents metadata associated with documents and information services. Metadata may include author relationship 522 (i.e., categorization of the author such as self, friend or third party), spatial distance 526 (i.e., spatial distance of client device 102 (FIG. 1) from reference entities, the author of the documents, the providers of the information services, the location of authoring of the documents and the like), media types 524 (i.e., media types used in the documents and information services), and nature of information services 528 (i.e., the sponsored, commercial or regular nature of information services). The metadata may be presented in index view 520 using textual representations or graphical representations such as special fonts, icons, colors, and the like.

FIG. 5(f) illustrates an exemplary folder view of the client user interface, in accordance with an embodiment. Here, folder view 530 displays the organization of a hierarchy of folders. The hierarchy of folders may be used to classify documents and associated information services.

FIG. 5(g) illustrates an exemplary content view of the client user interface, in accordance with an embodiment. Here, content view 540 is used to present and control documents and information services. The content view may incorporate user interface controls for the presentation and control of textual information 542 and user interface controls for the presentation and control of multimedia information 544. The multimedia information is presented through appropriate output components integrated in to client device 102 such as speaker 220. Information presented in content view 550 may include authoring information (e.g., author, time, location, and the like of the authoring of a document or information service).

FIG. 5(h) illustrates an exemplary content view of the client user interface, in accordance with an embodiment. Here, content view 550 is presented using minimal number of user interface graphical widgets. Such a rendering of the content view enables presentation of large amounts of information on client devices 102 with small displays 216.

FIG. 5(i) illustrates an alternate exemplary index view of the client user interface, in accordance with an embodiment. Here, index view 560 displays a list of documents on a client device with sufficient display resources such as a personal computer. The illustrated index view may be presented through a Web browser or a software application integrated into the personal computer. The Web browser or software application then acts as client 402 providing the functions described for the client. When the illustrated index view is presented on a Web browser, the system provides a Web site through a Web server integrated with the system server, which uses the illustrated index view as one aspect of the user interface of the Web site.

FIG. 5(j) illustrates an alternate exemplary content view of the client user interface, in accordance with an embodiment. Here, content view 570 displays a document on a client device with sufficient display resources such as a personal computer. The illustrated content view may be presented through a Web browser or a software application integrated into the personal computer. The Web browser or software application then acts as client 402 providing the functions described for the client. When the illustrated content view is presented on a Web browser, the system provides a Web site through a Web server integrated with the system server, which uses the illustrated content view as one aspect of the user interface of the Web site.

In some embodiments, the system specific communication protocol, which is overlaid on top of other protocols relevant to the underlying communication technology used, follows a request-response paradigm. Communication is initiated by client 402 with a request message to system server 106 for which system server 106 responds with a response message effectively establishing a “pull” model of communication. In other embodiments, client-system server communication may be implemented using “push” model-based protocols such as Short Message Service (SMS), Wireless Access Protocol (WAP) push or a system server 106 initiated TCP/IP session terminated at client 402.

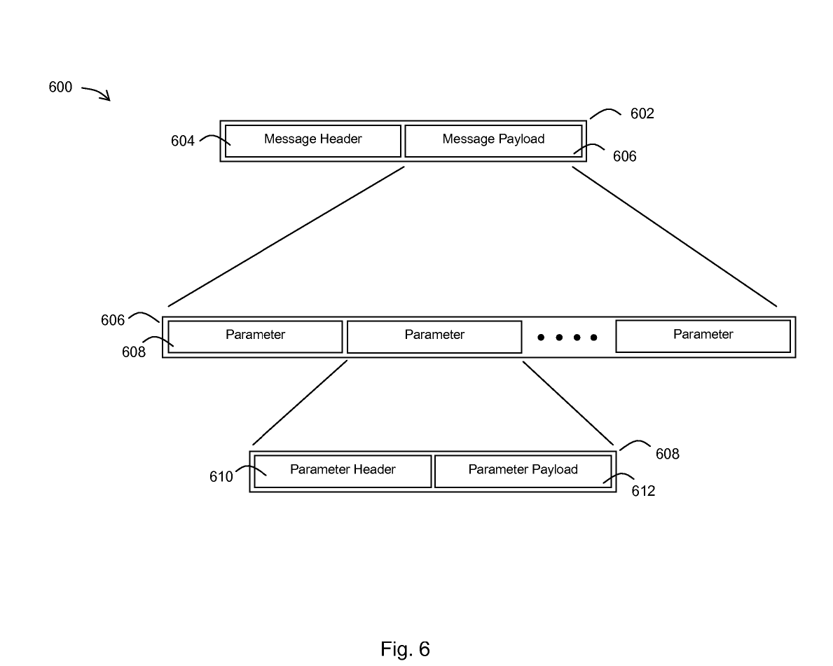

FIG. 6 illustrates an exemplary message structure for the communication protocol specific to the system. Here, message structure 600 is used to implement a system specific communication protocol. Message 602 includes message header 604 and message payload 606. Message payload 606 may include one or more parameters 608. Each of parameters 608 may further include parameter header 610 and parameter payload 612. Structures 602-612 may be implemented as fields of data bits or bytes, where the number, position, and type of bits may be used to instantiate a given value. Data bits or bytes may be used to represent numerical, text or binary values.

In some embodiments, message 602 may be transported using a standard protocol such as HyperText Transfer Protocol (HTTP), .Net, eXtensible Markup Language-Remote Protocol Call (XML-RPC), XML over HTTP, Simple Object Access Protocol (SOAP), web services, or other protocols and formats. In other embodiments, message 602 is encoded into a raw byte sequence to reduce protocol overhead, which may slow down data transfer rates over low bandwidth cellular communication channels. In this example, messages may be directly communicated over TCP or UDP.

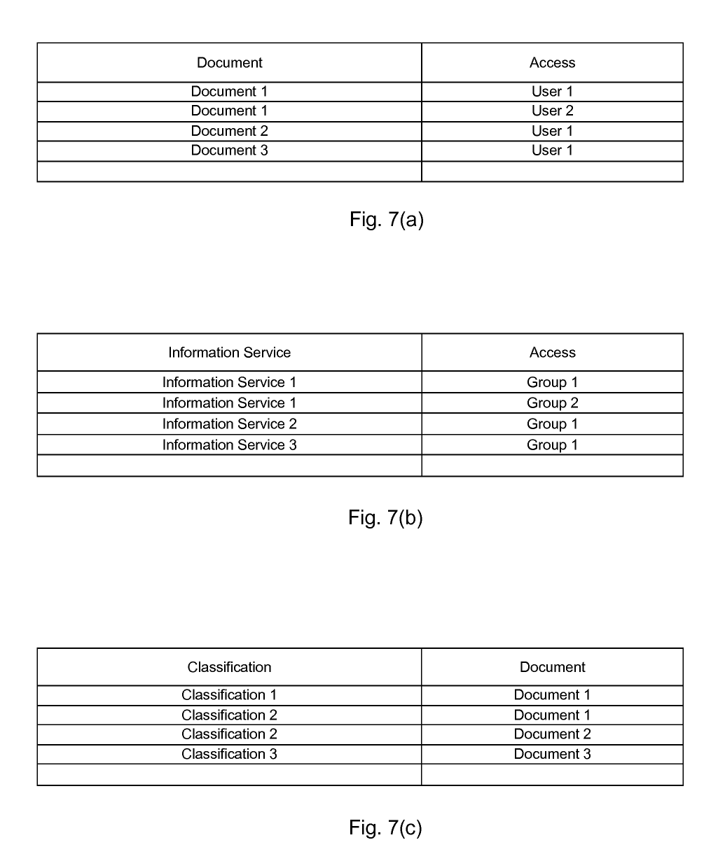

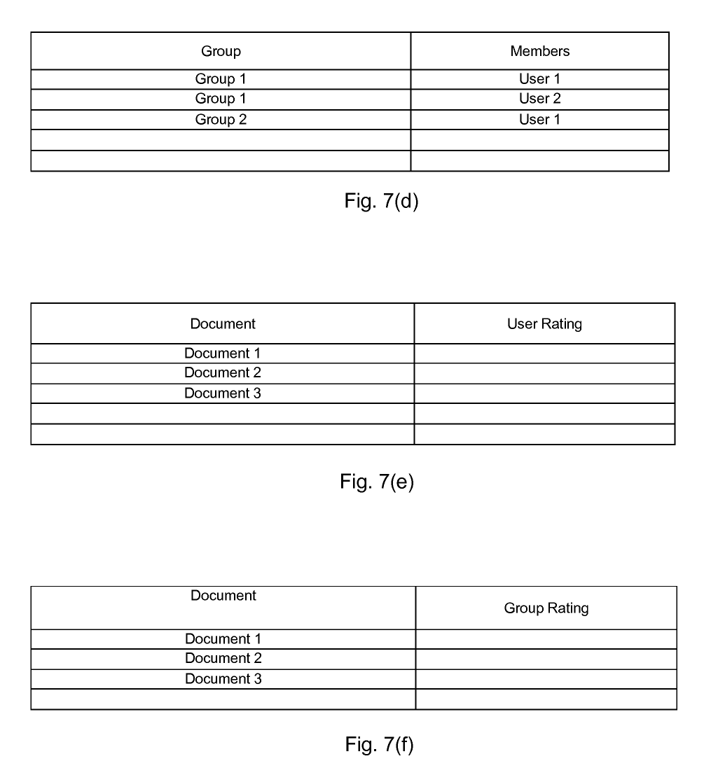

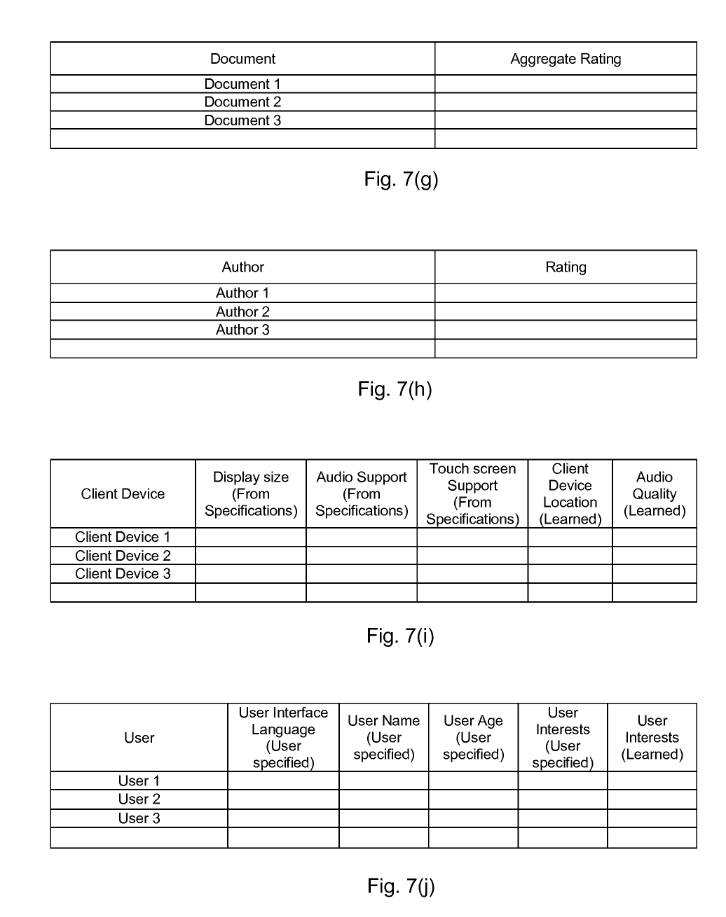

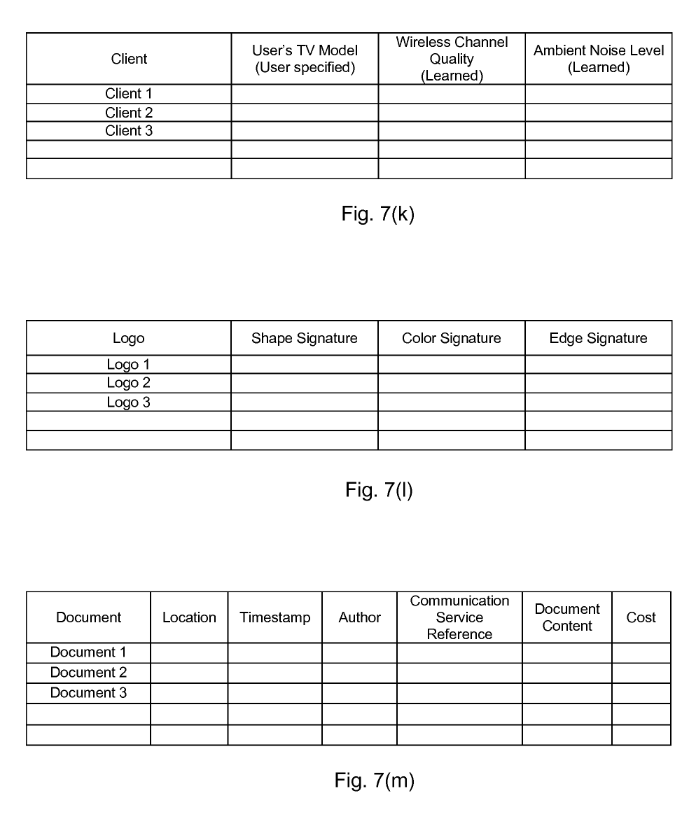

FIGS. 7(a)-7(l) illustrate exemplary structures for tables used in database 412. The tables illustrated in FIGS. 7(a) to 7(l) may be data structures used to store information in databases and knowledge bases. The definition of the tables illustrated in FIGS. 7(a)-7(l) is to be considered representative and not comprehensive, since the database tables can be expanded to include additional data relevant to delivering information services. For complete system operation, system 100 may use one or more additional databases though they may not be explicitly defined here. Further, system 100 may also use other data structures to organize and store information such as that described in FIGS. 7(a)-7(l). Data normalization may result in structural modification of databases during the operation of system 100.

FIG. 7(a) illustrates an exemplary user access privileges table, in accordance with an embodiment. Here, access privileges of users to various documents provided by the system 100 are listed. In some embodiments, the illustrated table may be used as a data structure to implement a user documents access privileges database.

FIG. 7(b) illustrates an exemplary user group access privileges table, in accordance with an embodiment. Here, access privileges of users to various user groups in the system 100 are listed. In some embodiments, the illustrated table may be used as a data structure to implement a user group documents access privileges database.

FIG. 7(c) illustrates an exemplary documents classifications table, in accordance with an embodiment. Here, classifications of documents as performed by the system 100 and as performed by users of the system 100 are listed. In some embodiments, the illustrated table may be used as a data structure to implement a documents classification database.

User access privileges for documents, user groups, and documents classifications may be stored in data structures such as those shown in FIGS. 7(a)-7(c), respectively. Access privileges may enable a user to create, edit, modify, or delete documents, and other data (e.g., user groups, document classifications, and the like).

FIG. 7(d) illustrates an alternative exemplary user groups table, in accordance with an embodiment. Here, the illustrated table lists various user group memberships. Additionally, privileges and roles of members (i.e., users) in a user group may be listed based on access privileges available to each user. Access privileges for each user may allow some users to author documents while others may be allowed only to use available documents. In some embodiments, users may also have access privileges to enable them to moderate user groups for the benefit of other members of a user group. In some embodiments, the illustrated table may be used as a data structure to implement a user groups database.

FIG. 7(e) illustrates an exemplary document ratings table listing individual users, in accordance with an embodiment. Here, the ratings for documents in the illustrated table may be derived from the time spent by individual users of system 100 using a document and information service or from document ratings explicitly specified by the users of system 100. In some embodiments, the illustrated table may be used as a data structure to implement a document user ratings database.

FIG. 7(f) illustrates an exemplary documents ratings table listing user groups, in accordance with an embodiment. Here, the ratings for documents in the illustrated table may be derived from the time spent by members of a user group of system 100 using a document or from document ratings explicitly specified by the members of a user group of system 100. In some embodiments, the illustrated table may be used as a data structure to implement a documents user groups ratings database.

FIG. 7(g) illustrates an exemplary aggregated documents ratings table for users and user groups, in accordance with an embodiment. Here, the ratings for documents in the illustrated table may be derived from the aggregated time spent by users of system 100 and members of user groups of system 100 using a document or from document ratings explicitly specified by users of system 100 and members of user groups of system 100. In some embodiments, the illustrated table may be used as a data structure to implement an aggregated documents ratings database.

FIG. 7(h) illustrates an exemplary author ratings table, in accordance with an embodiment. Here, the popularity of contributing authors who provide documents to system 100 is listed in the illustrated table. In some embodiments, author popularity may be determined by aggregating the popularity of documents to which an author has contributed. In other embodiments, an author's popularity may be determined using author ratings specified explicitly by users of system 100. In some embodiments, the illustrated table may be used as a data structure to implement an author ratings database.

FIG. 7(i) illustrates an exemplary client device characteristics table, in accordance with an embodiment. Here, the illustrated table lists characteristics (i.e., explicitly specified or system-learned characteristics) of client device 102. In some embodiments, explicitly specified characteristics may be determined from user input. Explicitly specified characteristics may include user input entered on a client user interface and characteristics of client device 102 derived from the specifications of the client device 102.

System-learned characteristics may be determined by analyzing a history of characteristics for client device 102, which may be stored in a knowledge base. Examples of characteristics derived from device specifications may include the display size, audio presentation and input features. System-learned characteristics may include the location of client device 102, which may be derived from historical location information uploaded by client device 102. System-learned characteristics may also include audio quality information determined by analyzing audio information authored using client device 102. In some embodiments, the illustrated table may be used as a data structure to implement a client device characteristics knowledge base.

FIG. 7(j) illustrates an exemplary user profile table, in accordance with an embodiment. Here, the illustrated table may be used to organize and store user preferences and characteristics. User preferences and characteristics may be either explicitly specified or learned (i.e., learned by system 100). In some embodiments, explicitly specified preferences and characteristics may be input by a user as data entered on the client user interface.

Learned preferences and characteristics may be determined by analyzing a user's historical preference selections and system usage. Explicitly specified preferences and characteristics may include a user's name, age, and preferred language. Learned preferences and characteristics may include user interests or ratings of various documents, classifications of documents (classifications created by the user and classifications used by the user), user group memberships, and individual user classifications. In some embodiments, the illustrated table may be used as a data structure to implement a user profiles knowledge base.

FIG. 7(k) illustrates an exemplary environmental characteristics table, in accordance with an embodiment. Here, the illustrated table may include explicitly specified and learned characteristics of the client device's environment. Explicitly specified characteristics may include characteristics specified by a user on a client user interface and specifications of client device 102 and communication network 104. Explicitly specified characteristics may include the model of a user's television set used by client 402, which may be used to generate control signals to the television set.

Learned characteristics may be determined by analyzing environmental characteristic histories stored in an environmental characteristics knowledge base. In some embodiments, learned characteristics may include data communication quality over communication network 104, which may be determined by analyzing the history of available bandwidth, rates of communication errors, and ambient noise levels. In some embodiments, ambient noise levels may be determined by measuring noise levels in visual and audio content captured by client 402. In some embodiments, the illustrated table may be used as a data structure to implement an environmental characteristics knowledge base.

FIG. 7(l) illustrates an exemplary logo information table, in accordance with an embodiment. In some embodiments, data regarding logos and features extracted from logos may be stored in the illustrated table. Specialized image processing algorithms may be used to extract features such as the shape, color, and edge signatures from logos. The extracted information may be stored in the illustrated table as annotative information associated with the logos. In some embodiments, the illustrated table may be used as a data structure to implement a logo information database.

FIG. 7(m) illustrates an exemplary document database table, in accordance with an embodiment. In some embodiments, the document database table contains the textual, audio, and visual data contained in the documents and their associated metadata. In some embodiments, the illustrated table may be used as a data structure to implement a documents database. The documents database serves as the key store of information used to store, manage, and retrieve documents in the system.

FIGS. 7(a)-7(m) illustrate exemplary structures for tables used in databases and knowledge bases in some embodiments. In other embodiments, databases and knowledge bases may use other data structures to achieve similar functionality. System server 106 may also include knowledge bases such as a language knowledge base (i.e., a knowledge base that defines the grammar, syntax, and semantics of languages), a thesaurus knowledge base (i.e., a knowledge base of words with similar meaning), a Geographic Information System (GIS) (i.e., a knowledge base providing mapping information for generating geographical maps and cross referencing postal and geographical addresses), an ontology knowledge base (i.e., a knowledge base of classification hierarchies of various knowledge domains), a database of information services, and the like.

Operation

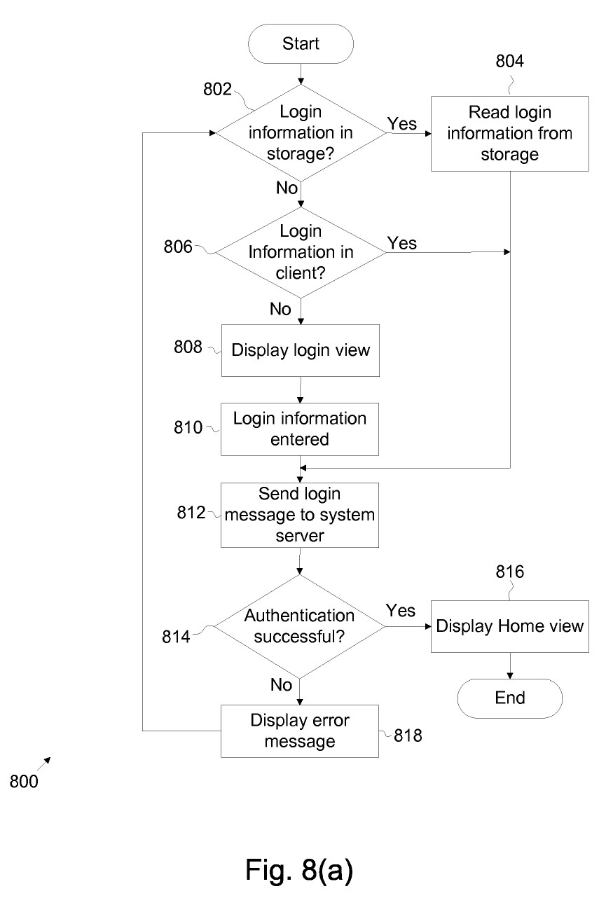

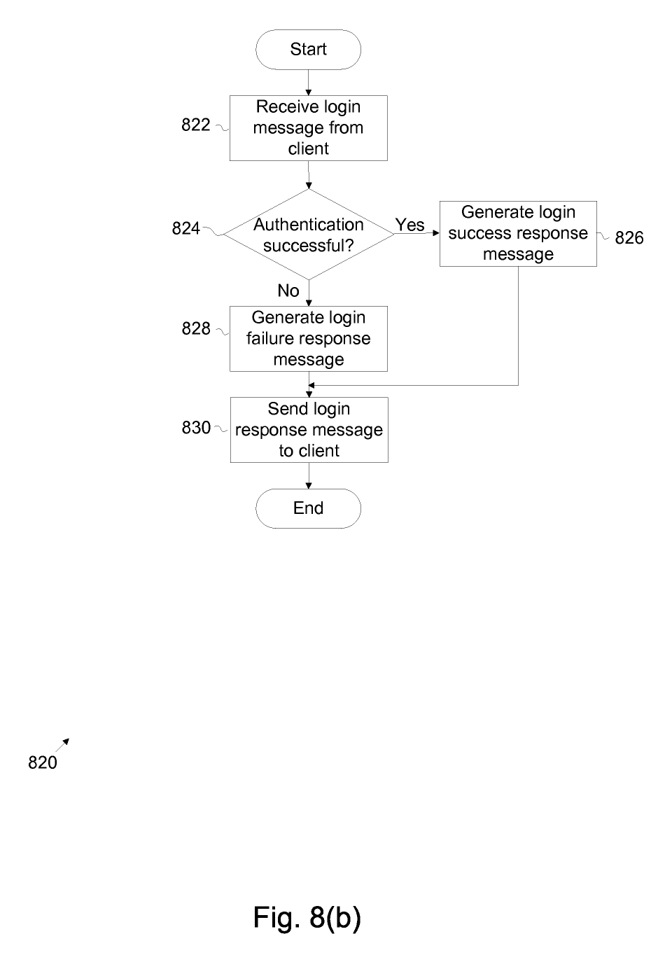

FIG. 8(a) illustrates an exemplary process 800 for starting a client, in accordance with an embodiment. Process 800 and other processes of this document are implemented as a set of modules, which may be process modules or operations, software modules with associated functions or effects, hardware modules designed to fulfill the process operations, or some combination of the various types of modules.

The modules of process 800 and other processes described herein may be rearranged, such as in a parallel or serial fashion, and may be reordered, combined, or subdivided in various embodiments. Here, an evaluation is made as to whether login information is stored on client device 102 (802). If login information is stored, then the information is read from storage 234 on client device 102 (804). If login information is not available in storage 234 on client device 102, another determination is made as to whether login information is embedded in client 402 (806).

If information is not embedded in client 402, then a login view is displayed on client 402 (808). Login information is entered by a user (810). Once the login information is obtained by client 402 from storage, client embedding or user input, a login message is generated and sent to system server 106 (812). Upon receipt, system server 106 authenticates the login information and sends a response message with the authentication status. (814).

Login information may include a textual identifier (e.g., user name, password), a visual identifier (e.g., visual content of a user's face), or an audio identifier (e.g., user's voice or speech). If authentication is successful, the home view of the client 402 user interface may be displayed (816) on display 216. If authentication fails, then an error message may be displayed (818). In other embodiments, process 800 may be varied and is not limited to the above description.

A user interacts with the system 100 through client 402 integrated into client device 102. User launches client 402 by selecting client 402 and launching it using a native user interface of client device 102. Client device 102 may also be configured to launch client 402 automatically upon clicking a specific key or upon power-up activation.

Upon launching, client 402 presents a login view of a user interface to a user on display 216 on client device 102 for entering a login user identification and password as shown in FIG. 5(a). Referring back to FIG. 8(a), upon user entry of information, client 402 initiates communication with system server 106 by opening a TCP/IP socket connection to system server 106 using the TCP/IP stack integrated into client device 102 software environment.

Client 402 then composes a login request message including the user identification and password as parameters. Client 402 then sends the request message to system server 106 to authenticate and authorize a user's privileges in the system. Upon verification of a user's privileges, system server 106 responds with a login response message indicating successful login of the user. Likewise, the system server 106 responds with a login response message indicating failure of the login, if a login attempt was unsuccessful (i.e., invalid user identification or password was presented to the system server 106). In some embodiments, a user may be prompted to attempt another login. Authentication information may also be stored locally on client 402 or embedded in client 402, in which case, the user does not have to explicitly enter the information.

FIG. 8(b) illustrates an exemplary process for authenticating a client on system server 106, in accordance with an embodiment. Here, process 820 is initiated when a login message is received from client 402 (822). The received login message is authenticated by system server 106 (824). If the login information in the login message is authenticated, then a login success response message is generated (826). However, if the login information in the login message is not authenticated, then a login failure response message is generated (828). Regardless of whether a login success response message or a login failure response message is generated, the response message is sent to client 402 (830).

In some embodiments, authentication may be performed using a text-based user identifier and password combination. In other embodiments, audio or video inputs are used to authenticate users using appropriate techniques such as voice recognition, speech recognition, face recognition and/or other visual recognition algorithms. Authentication may be performed locally on client 402 or remotely on system server 106 or with the authentication process distributed over both client 402 and system server 106. Authentication may also be done with SSL client certificates or federated identity mechanisms such as Liberty. In some embodiments, authentication may be deferred to a later instant during the use, instead of at the launch of client 402. Further, explicit authentication may be eliminated if implicit authentication mechanisms (e.g., client/user identifier built into a data communication protocol or client 402) are available.

If a user is authenticated, client 402 presents the home view on display 216 as shown in FIG. 5(c). The home view may display captured visual content, similar to previewing a visual scene to be captured in a camera viewfinder. A user may point camera 202 at a scene of his choice and snap a still image by clicking on the designated camera shutter key on client device 102. In other embodiments, the camera shutter (i.e., the start of capture of visual content) may be triggered by clicking a designated soft key on client device 102, by selecting an option displayed on a touch sensitive display or by speaking a command into the microphone.

To aid a user in choosing a size or zoom factor and the spatial orientation of the visual scene in the viewfinder that enables the optimal performance of the system, reference marks 510 may be superposed on the live camera imagery i.e. viewfinder. A user may move the position of client device 102 relative to objects in the visual scene or adjust controls on the client 402 or client device 102 (e.g., adjust the zoom or spatial orientation) in order to align the captured visual content with the reference marks on the viewfinder.

While the above discussion describes the capture of a still image, client 402 may also capture a sequence of still images or video. A user may perform a different interaction at the client user interface to capture sequence of still images or video. Such interaction may be the clicking of a designated physical key, soft key, touch sensitive display, a spoken command, or a different method of interaction on the same physical key, soft key, or touch sensitive display used to capture a single still image. Such a multiple still image or video capture feature is especially useful in cases where the visual scene of interest is large enough so as not to fit into a single still image with sufficient spatial resolution for further processing of the visual content by system 100.

In addition to capture of visual content, the user may also input audio information through the microphone 204 integrated into client device 102. Client 402 may incorporate controls for triggering and controlling the capture of audio information. In some embodiments, client 402 may also input the audio information from storage 234, database 412, or other components of the system. Further, the user may also input information using other input components such as keypad 206 and touch sensor 208. In some embodiments, client 402 may also input metadata from sensors such as positioning system 210, accelerometer 212, and clock 214.

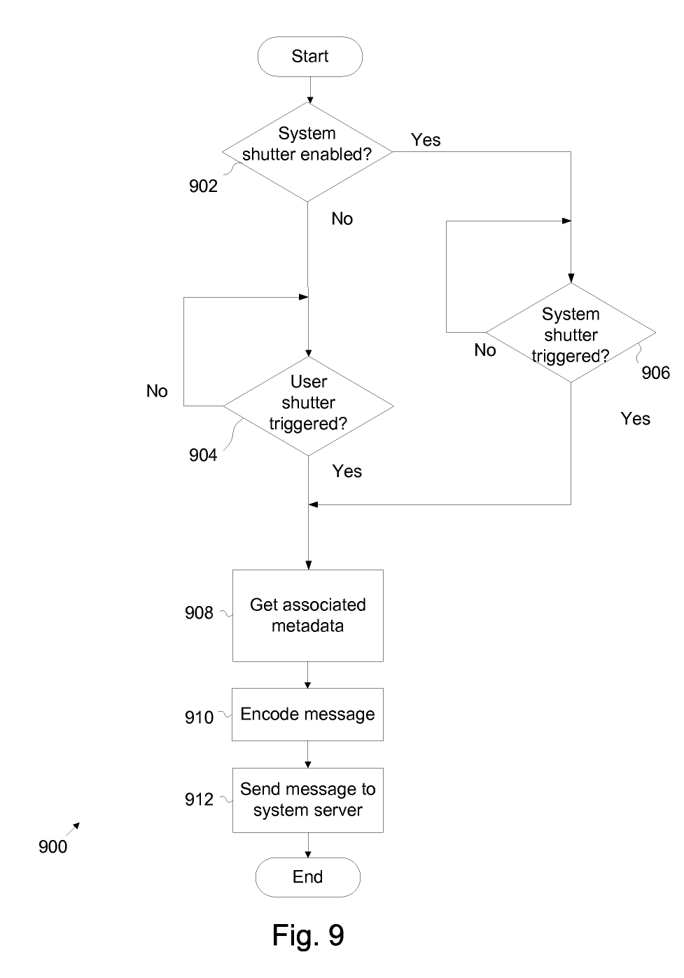

FIG. 9 illustrates an exemplary process for capturing multimodal information and starting client-system server interaction, in accordance with an embodiment. Here, a determination is made as to whether to use the user-triggered mode of operation or system-triggered mode of operation (902). Upon triggering by the user (904), in the case of user triggered mode of operation or upon triggering by the system (906), in the case of system triggered mode of operation, multimodal input and associated metadata are obtained by client 402 from the components of the client 402 and client device 102 (908). Then, the multimodal inputs are encoded (910) along with the associated metadata and communicated to system server 106 (912). In other embodiments, process 900 may be varied and is not limited to the above description. In some embodiments, the multimodal inputs and metadata may be streamed or communicated to system server 106 over an extended period of time.

In the system triggered mode of operation, client 402 captures multimodal information when a predefined criterion is met. Examples of predefined criteria include spatial proximity of the user and/or client device to a predefined location, a predefined time instant, a predefined interval of time, motion of the user and/or client device, spatial orientation of the client device, characteristics of captured visual information (e.g., brightness, change in brightness, motion of objects in visual content, etc.), characteristics of captured visual information (e.g., change in ambient noise level, spoken user commands), and other criteria defined by the user and system 100.

In some embodiments, the home view of the user interface of client 402 may also provide indicators 512, which provide indicators of visual and audio content capture quality such as brightness, contrast, focus, and recording level. Indicators 512 may also provide information or indications on the state of client device 102 such as its location, spatial orientation, motion, and time. Visual and audio content capture quality parameters may be determined from the captured visual content and audio content.

Likewise, the state information of client 402 obtained from internal logic states of client 402 are presented on the user interface. The visual and audio content capture quality and client state indicators help a user capture visual and audio content and also ensures that the captured visual and audio content is suitable for processing by system 100. Capture of the visual and audio content may also be controlled implicitly by monitoring predefined factors such as the motion of client device 102 or visual content displayed on the viewfinder or the clock 214 integrated into client device 102. In some embodiments, visual and audio content retrieved from storage 234 may be presented on the user interface.

Client 402 uses the captured visual and audio information in conjunction with associated metadata and user inputs to compose a request message. The request message may include captured visual and audio information encoded into a suitable format (e.g., JPEG, GIF, CCITT Fax, MPEG, H.26x, MP3, WMA, and WAV) and associated metadata. In some embodiments, the encoding of the message and the content in the message may be customized to the available resources of client device 102, communication network 104, and system server 106. For example, in some embodiments where the data rate capacity of communication network 104 is very low, visual content may be encoded with reduced resolution and greater compression ratio for fast transmission over communication network 104.

In other embodiments, where the data rate capacity of communication network 104 is greater, visual content may be encoded with greater resolution and lesser compression ratio. In some embodiments, the visual and audio characteristics extracted from the visual and audio content may be communicated to the system server 106. Further, in some embodiments, resource aware signal processing algorithms that adapt to the instantaneous availability of computing and communication resources in the client device 102, communication network 104 and system server 106 may be used. The message may be formatted and encoded per various data communication protocols and standards (e.g., the system specific message format described elsewhere in this document). Once encoded, the message is communicated to system server 106 through communication network 104.

Communication of the encoded message in an environment such as Java J2ME involves requesting the software environment to open a TCP/IP socket connection to an appropriate port on system server 106 and requesting the software environment to transfer the encoded message data through the connection. The TCP/IP protocol stack integrated into the software environment on client 402 and the underlying protocols built into communication network 104 components manage the delivery of the encoded message data to the system server 106. In some embodiments, the communication may also be accomplished over circuit-switched communication channels using proprietary communication protocols.

In some embodiments, front-end server 404 on system server 106 receives the request message and forwards it to application engine 416 after verifying the integrity of the message. The message integrity verification includes the verification of the originating IP address to create a network firewall mechanism and verification of the structure of the contents of the message to identify corrupted data that may potentially damage application engine or cause dysfunction.

Application engine 416 decodes the message and parses the message into its constituent parameters. Natural media data (e.g., audio, still images, and video) contained in the message is forwarded to signal processing engine 406 for decoding and enhancement. The processed natural media data is then forwarded to recognition engine 408 for extraction of recognizable elements embedded in the natural media data.

Logic in application engine 416 uses machine-interpretable information obtained from recognition engine 408 along with metadata and user inputs embedded in the message, information from knowledge bases and optionally links to other documents and information services, to construct new multimedia documents or to retrieve relevant multimedia documents from the system.

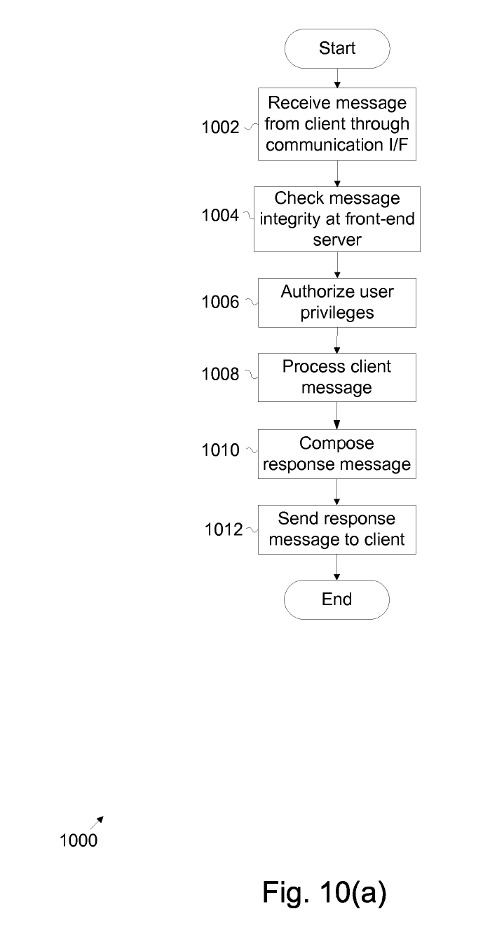

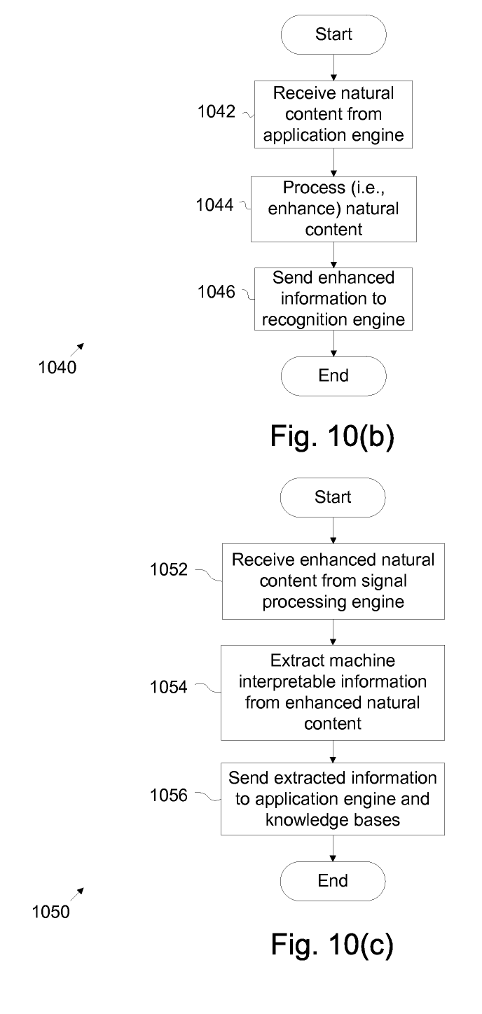

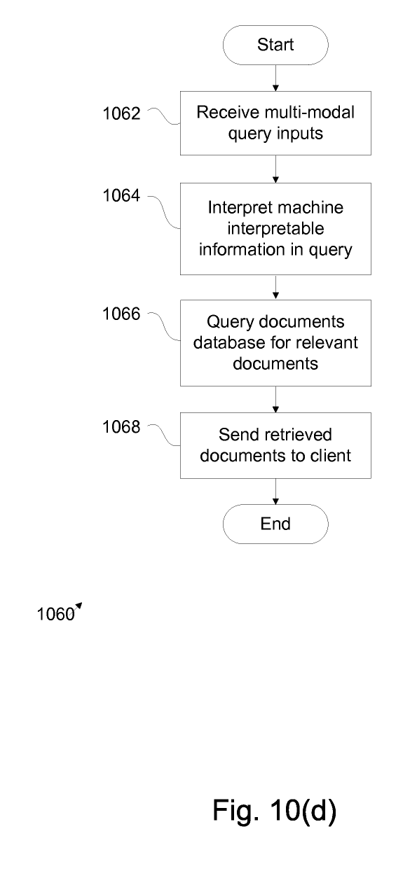

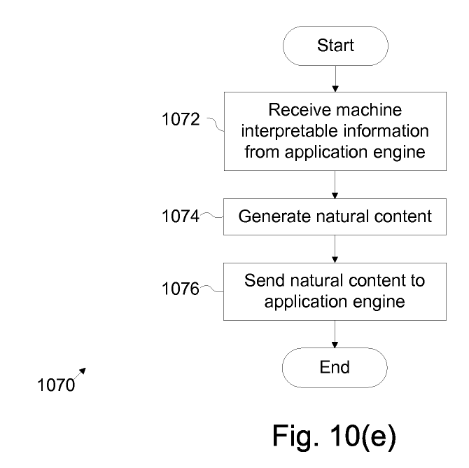

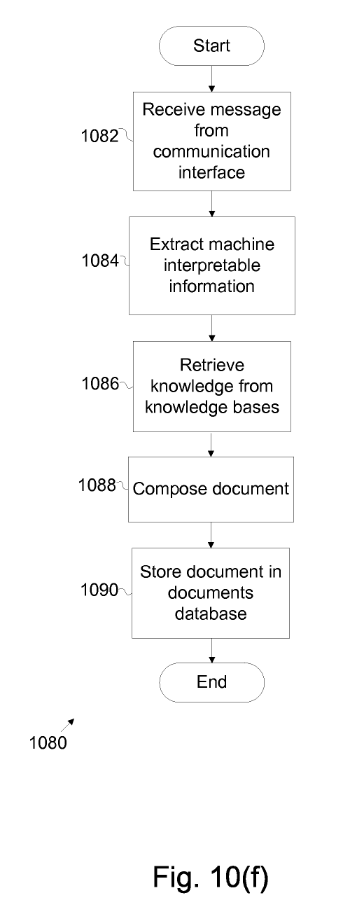

FIG. 10(a) illustrates an exemplary process for client-system server interaction, in accordance with an embodiment. Process 1000 is initiated when a message is received through communication interface 238 (1002). Once received, front-end server 404 checks the integrity of the received message (1004). Application engine 416 authorizes access privileges for the user upon authentication, as described above (1006). Once authorized, application engine 416 processes the message as described above (1008). Additional processes that may be included in the processing of the message are described below in connection with FIGS. 10(b)-10(f).

Application engine 416 then generates or composes a response message (1010). Once the processing is complete, the response message is sent from system server 106 to client 402 (1012). In other embodiments, process 1000 may be varied and is not limited to the description provided above.

FIG. 10(b) illustrates an exemplary process for processing natural content by signal processing engine 406, in accordance with an embodiment. Process 1040 is initiated when natural content is received by signal processing engine 406 from application engine 416 (1042). Once received, the natural content is processed (i.e., enhanced) (1044). The signal processing engine 406 decodes and enhances the natural content as appropriate.

The enhanced content is then forwarded to recognition engine 408 that extracts machine interpretable information form the enhanced natural content, which is described in greater detail below in connection with FIG. 10(c). Enhanced natural content is sent to recognition engine 408 (1046). Examples of enhancements performed by the signal processing engine include normalization of brightness and contrast of visual content. In other embodiments, process 1040 may be varied and is not limited to the above description.

FIG. 10(c) illustrates an exemplary process for extracting information from enhanced natural content by the recognition engine 408, in accordance with an embodiment. In process 1050, enhanced natural content is received from signal processing engine 406 by the recognition engine 408 (1052).

Once received, machine-interpretable information is extracted from the enhanced natural content (1054) by the recognition engine 408. Examples of extraction of machine-interpretable information by recognition engine 408 include the extraction of textual information from visual content by a text recognition engine module and the extraction of textual information from audio content by a speech recognition engine module, of recognition engine 408. The extracted information (e.g., machine-interpretable information) may be sent to application engine 416 and relevant knowledge bases (1056). In other embodiments, process 1050 may be varied and is not limited to the descriptions given.

FIG. 10(d) illustrates an exemplary process for retrieving documents from the documents database by application engine 416 using multimodal inputs, in accordance with an embodiment. In some embodiments, process 1060 is initiated when a query for documents composed of multimodal inputs is received from the client (1062). The application engine 416 interprets machine interpretable information from any multimedia content present in the query using recognition engine 408 (1064).

After interpretation of the machine interpretable information, the application engine 416 queries the documents database 412 for relevant documents (1066) that match the query in the form of the multimodal inputs. The retrieved documents are then communicated for presentation on the client user interface using the index or content views (1068). Components of the documents identified as relevant to the query may also be sent to the synthesis engine 410 by the application engine 416 to generate natural content from machine interpretable content. In other embodiments, process 1060 may be varied and is not limited to the above description.

In some embodiments, a user may input the query for the documents as simple textual input on keypad 206 and receive a list of identified relevant documents in the index view 520 of the client user interface. The user may optionally sort and filter the list of documents presented in index view 520 based on criteria such as the author, location of document creation, time of document creation, and accessibility to the documents. If the information has been modified since the initial creation, metadata on the modification history such as author, location, and time may also be presented to the user. The user also has the ability to filter the information presented based on the modification metadata. Any request for a new filtering or sorting of the information results in a request generated by client 402 with the appropriate parameters and a response from system server 106 with the new information.

FIG. 10(e) illustrates an exemplary process for generating natural content from machine interpretable information by synthesis engine 410, in accordance with an embodiment. Here, process 1070 is initiated when synthesis engine 410 receives machine interpretable information from the application engine 416 (1072). Natural content is generated by synthesis engine (1074) and sent to application engine 416 (1076). In other embodiments, process 1070 may be varied and is not limited to the description provided.

FIG. 10(f) illustrates an exemplary process for creating documents from multimodal inputs and storing them in the documents database by application engine 416, in accordance with an embodiment. In some embodiments, process 1080 is initiated when a document creation message is received from the communication interface (1082). Any machine-interpretable information available in the multimodal content in the message is then extracted by recognition engine 408 (1084). The application engine 416 queries the knowledge base 412 for relevant knowledge (i.e., information) to be added to the document (1086). The retrieved knowledge elements, the extracted machine-interpretable information, the multimodal inputs, and associated metadata received from client 402 are used to compose a document (1088). The composed documents are then stored in the documents database (1090). In other embodiments, process 1080 may be varied and is not limited to the above description.

The created documents are added to the documents database in system 100 with the appropriate access privileges as specified by the user or as determined by the system. In addition, the system server 106 may incorporate the contents of the documents into an index of the documents present in the system. Such an index enables fast location and retrieval of documents corresponding to user queries. The created documents may also be incorporated into information presented in index view 520 on the client user interface. The user may then open the document for presentation in its entirety in content views 540 or 550 of the client user interface.

In other embodiments, different alternative processes may be implemented and variations of individual steps may be performed beyond those described above for processes described in connection with FIGS. 10(a)-10(f). In some embodiments, document and information services sourced from outside system 100 are routed through system server 106. In other embodiments, document and information services sourced from outside system 100 are obtained by client 402 directly from the source without the intermediation of system server 106.

In some embodiments, when a plurality of documents is available for presentation to a user, the system might automatically select and present a single document on client 402. Such automatic selection of documents may be determined by criteria such as a document relevance factor, availability of documents, nature of the documents (i.e. sponsored documents, commercial documents, etc.), user preferences, and the like.

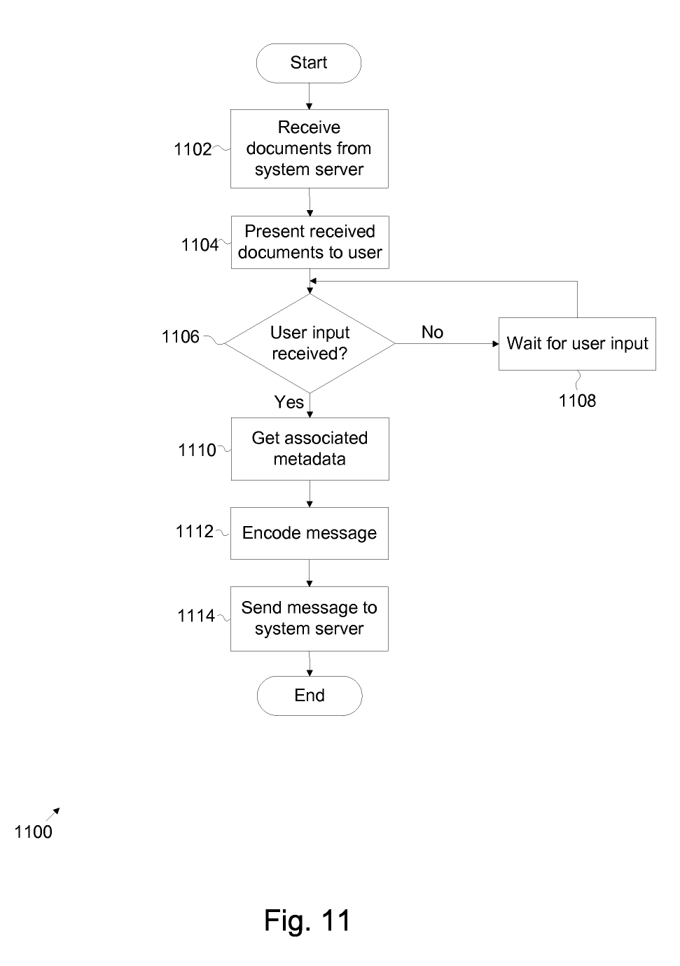

FIG. 11 illustrates an exemplary process for interacting with documents on client 402, in accordance with an embodiment. Process 1100 presents the operation of system 100 while a user browses and interacts with documents presented on the client 402. Documents are received from system server 106 upon request by the client 402 (1102). The documents are then presented to the user on the client 402 user interface (1 104). Then, a determination is made as to whether the user has provided input (e.g., selected a particular document from those presented) (1 106). If the user does not input information, then a delay is invoked while waiting for user input (1108).

If user input is entered, then metadata associated with the input is gathered (1110). The metadata is encoded into a message (1112), which is sent to system server 106 in order to place the user's input into effect (11 14). Continued interaction of the user with system 100 through client 402 user interface may result in a plurality of the sequence of operations described above for the request and presentation of documents. In other embodiments, process 1100 may be varied and is not limited to the description above. The document presented may also have embedded hyperlinks, which enable a user to request additional information by selecting the hyperlinks. Interacting with the client user interface to select a document or a hyperlink embedded in a document to request associated documents or information services follows a sequence of operation similar to process 1100.

In case the format or the media type used in a document does not match the presentation capabilities of client device 102, application engine 416 may use synthesis engine 410 and signal processing engine 406 to transform or reorganize the document into a suitable format. For example, speech content may be converted to a textual format or graphics resized to suit the display capabilities of client device 102. A more advanced form of transformation may be creating a summary of a lengthy text document for presentation on a client device 102 with a restricted (i.e., small) display 216 size. Another example is reformatting a World Wide Web page derived document to accommodate a restricted (i.e., small) display 216 size of a client device 102. Examples of client devices with restricted display 216 sizes include camera phones, PDAs and the like.

In some embodiments, encoding of the information services may be customized to the available computing and communication resources of client device 102, communication network 104, and system server 106. For example, in some embodiments where the data rate capacity of communication network 104 is very low, the multimodal content may be encoded with reduced resolution and greater compression ratio for fast transmission over communication network 104. In other embodiments, where the data rate capacity of communication network 104 is greater, multimodal content may be encoded with greater resolution and lesser compression ratio. The choice of encoding used for the documents may also be dependent on the computational resources available in client device 102 and system server 106. Further, in some embodiments, resource aware signal processing algorithms that adapt to the instantaneous availability of computing and communication resources in the client device 102, communication network 104 and system server 106 may be used.

When a user selects a hyperlink or clicks a physical or soft key on client device 102, a number of parameters of a user interaction are transmitted to system server 106. These include, but are not limited to, key clicked by a user, position of options selected by a user, size of selection of options selected by a user, duration of selection of options selected by a user, and the time of selection of options by a user. These inputs are interpreted by system server 106 based on the state of the user's interaction with client 402 and appropriate information services are presented on client device 102.

The input parameters communicated from client 402 may also be stored by system 100 to infer additional knowledge from the historical data of such parameters. For example, the difference in time between two consecutive interactions with client 402 may be interpreted as the time a user spent on using the document that he was using between the two interactions. In another example, the length of use of a given document by multiple users may be used as a popularity measure for the document.

A user may also elect to view documents sorted or filtered based on criteria such as the author, origin location, origin time, and accessibility to the documents. If a document has been modified since its initial creation, metadata on the modification history such as author, location, time may also be presented to a user. A user may filter documents presented based on their modification metadata, as described above. Any request for additional documents or a new filtering or sorting of documents may result in a client request with appropriate parameters and a response from system server 106 with new documents. In some embodiments, incremental user and sensor inputs may also be used to progressively narrow a list of documents relevant to a given context. For example, relevant documents may be identified after each character of a textual user input has been entered on the client user interface.

In some embodiments, client 402 may be actively monitoring the environment of a user through available sensors and automatically present, without any explicit user interaction, documents that are relevant to inputs generated from the available sensors. Likewise, client 402 may also automatically present documents when a change occurs in the internal state of client 402 or system server 106. For example, client 402 may automatically present documents authored by a friend upon creation of the document. A user may also be alerted to the availability of existing or updated documents without any explicit inputs from the user. For example, when a user nears a spatial location that has a document created by a friend, client 402 may automatically recognize the proximity of a user to the location with which the document is associated by monitoring the location of client device 102, sending an alert (e.g., an audible alarm, beep, tone, flashing light, or other audio or visual indication).

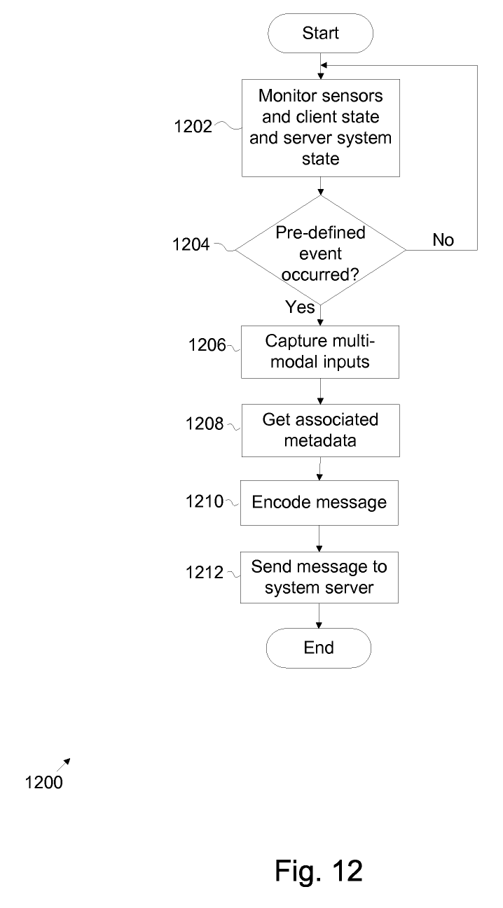

FIG. 12 illustrates an exemplary process for requesting documents when client 402 is running in autonomous mode and presenting relevant documents without user action, in accordance with an embodiment. Here, process 1200 may be implemented as a sequence of operations for presenting documents automatically. In some embodiments, client device 102 monitors the state of system server 106 and uses sensors to monitor the state of client 402 (1202).

As the state of client 402 is monitored, a determination is made as to whether a predefined event has occurred (1204). If no predefined event has occurred, then monitoring continues. If a predefined event has occurred, then multimodal information is captured automatically (1206).

Once the multimodal information is captured, associated metadata is gathered from various components of the client 402 and client device 102 (1208). Once gathered, the metadata is encoded in a request message along with the captured multimodal information (1210). The request message is sent to system server 106 (1212). In other embodiments, process 1200 may be varied and is not limited to the description provided above.

In the operation of embodiments of system 100 presented above, client 402 communicates immediately with system server 106 upon user interaction on a user interface at client 402 or upon triggering of predefined events when client 402 is operating in an automatic document presentation mode. However, communication between client 402 and system server 106 may also be deferred to a later instant based on criteria such as the cost of communicating, the speed or quality of communication network 104, the availability of system server 106, or other system-identified or user-specified criteria.

Other Features

Authentication, Authorization and Accounting (AAA) features may also be provided in various embodiments. Users of system 100 may restrict access to documents and associated information services based on access privileges specified by them. Users may also be given restricted access to documents and associated information services based on their access privileges. Operators of system 100 and documents providers may also specify access privileges. AAA features may also indicate access privileges for shared documents and information services. Access privileges may be specified for a user, user group or a document classification.

The authoring view in a client user interface may support commands to specify access rights for documents. The accounting component of the AAA features enables system 100 to monitor use of documents by users, allows users to learn other users' interests, and provides techniques for the evaluation of the popularity of documents by analyzing the aggregated interests of users in individual documents, the tracking of usage of system 100 by users for billing purposes and the like. Authentication and authorization may also provide means for executing financial transactions (e.g., purchasing products and services embedded in a document). As used herein, the term “authenticatee” refers to an entity seeking authentication e.g., a user, user group, operator, provider of document.

Another feature of system 100 is support for user groups. User groups enable sharing of documents among groups. User groups also enable efficient specification of AAA attributes for documents for a group of users. User groups may be nested in overlapping hierarchies. User groups may be created automatically by system 100 (i.e., through analysis of available documents and their usage) or manually by the operators of system 100. Also, user groups may be created and managed by users using the Settings view on the user interface of client 402 as illustrated by FIG. 5(b). The Settings view may also support features for management of groups such as deletion of users, deletion of entire groups and creation of hierarchical groups. The AAA rights of individual users in each group may also be specified. Support for user groups also enables the members of a group to jointly author a document. An example of a simple group is a list of friends of a particular user.

The AAA features may also enable use of digital rights management (DRM) to manage documents. While the authentication and authorization parts of AAA enable simple management of users' privileges to access and use documents, DRM provides enhanced security, granularity and flexibility for specifying user privileges for accessing and using documents and other features such as user groups and classifications. The authentication and authorization features of AAA provide the basic authentication and authorization required for the advanced features offered by DRM. One or more DRM systems may be implemented to match the capabilities of different system server 106 and client device 102 platforms or environments.

Some embodiments support classification of documents through explicit specification by users or automatic classification by system 100 (i.e., through analysis of the components of the document). When classifications are created and made available to a user, the user may select classes of documents from menus on a user interface on client 402. Likewise, a user may also classify documents into new and existing classes. The classification of documents may also have associated AAA properties to restrict access to various classifications. For example, classifications generated by a user may or may not be accessible to other users. For automatic classifications of documents, system 100 uses usage statistics, user preferences, media types used in documents, components of the documents.

In some embodiments, the use of AAA features for restricting access to documents and the accounting of the consumption of documents may also enable the monetization of documents through the support for commercial and sponsored documents. Commercial and sponsored documents may be authored and provided by third parties or other users of system 100. An example of a commercial document is an “Analyst report” that is available to a user for a fee. An example of a sponsored information service is an advertisement. The accounting part of the AAA features monitors the use of commercial documents, bills users for the use of the commercial documents, and compensates providers of the commercial documents for providing the commercial documents. Similarly, the accounting part of the AAA features monitors the use of sponsored documents and bills providers of the sponsored documents for providing the sponsored documents.

In some embodiments, users may be billed for use of commercial documents using a prepaid, subscription, or pay-as-you-go transactional model. In some embodiments, providers of commercial documents may be compensated on an aggregate or transactional basis. In some embodiments, providers of sponsored documents may be billed for providing the sponsored documents on an aggregate or transactional basis. In addition, shares of the revenue generated by commercial or sponsored documents may also be distributed to operators of system 100. In some embodiments, a single document may also include regular, sponsored, and commercial document features.

In some embodiments, users may access documents though a website integrated with system 100. The website may also optionally enable users to sort and search for documents based on keywords, time, location, size and other metadata. Optionally, the website may also act as a user interface for the authoring, management, retrieval, and presentation of documents and associated information services similar to the client.

Sample Applications

The document authoring and management tools presented enable a number of innovative applications. An exemplary set of applications is presented in this section. However, the scope of the invention is not restricted to the applications presented here.

Text extracted from visual imagery of printed matter such as books and newspapers may be used to compose booklets of information. A series of still images or video sequences is automatically converted by the system into a booklet with a set of pages and a title or cover page. The demarcation of the captured multimedia content into pages can either be done manually or automatically by the system based on the spatial and temporal relationship between the individual still images and video sequences. The spatial and temporal relationships are derived from the metadata associated with the multimedia content and also through analysis of multimedia content to determine the user and/or client device motion and spatial orientation. Besides, the booklet may also be enhanced through relevant information services such as dictionary, thesaurus, reader comments, and additional in-depth analysis services.

Users in the audience of a presentation can use the system to compose a multimedia document of the presentation. The composition of the presentation document is similar to the composition of the booklet described above. Also, additional information services relevant to the document can be provided by the system. Sponsored information such as advertisements and coupons may be presented to the user on the client user interface alongside the document.

Visual imagery of a business card can be used by the system to generate an electronic version of the information in the card for insertion into the client device contacts database or for storage on the system server. In addition, information services such as driving directions to the addresses in the business card may also be provided.

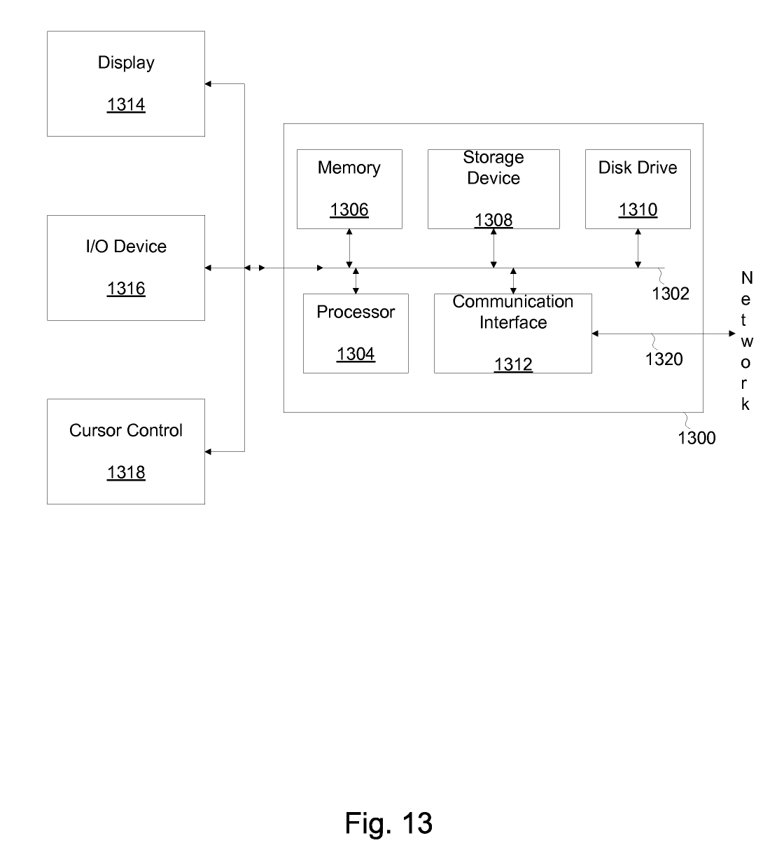

FIG. 13 is a block diagram illustrating an exemplary computer system suitable for authoring and managing multimodal documents. In some embodiments, computer system 1300 may be used to implement computer programs, applications, methods, or other software to perform the above-described techniques for authoring and managing multimodal documents such as those described above. Computer system 1300 includes a bus 1302 or other communication mechanism for communicating information, which interconnects subsystems and devices, such as processor 1304, system memory 1306 (e.g., RAM), storage device 1308 (e.g., ROM), disk drive 1310 (e.g., magnetic or optical), communication interface 1312 (e.g., modem or Ethernet card), display 1314 (e.g., CRT or LCD), input device 1316 (e.g., keyboard), and cursor control 1318 (e.g., mouse or trackball).

According to some embodiments, computer system 1300 performs specific operations by processor 1304 executing one or more sequences of one or more instructions stored in system memory 1306. Such instructions may be read into system memory 1306 from another computer readable medium, such as static storage device 1308 or disk drive 13 10. In some embodiments, hard-wired circuitry may be used in place of or in combination with software instructions to implement the system.

The term “computer readable medium” refers to any medium that participates in providing instructions to processor 1304 for execution. Such a medium may take many forms, including but not limited to, nonvolatile media, volatile media, and transmission media. Nonvolatile media includes, for example, optical or magnetic disks, such as disk drive 1310. Volatile media includes dynamic memory, such as system memory 1306. Transmission media includes coaxial cables, copper wire, and fiber optics, including wires that comprise bus 1302. Transmission media may also take the form of acoustic or light waves, such as those generated during radio wave and infrared data communications.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer may read.

In some embodiments, execution of the sequences of instructions to practice the system is performed by a single computer system 1300. According to some embodiments, two or more computer systems 1300 coupled by communication link 1320 (e.g., LAN, PSTN, or wireless network) may perform the sequence of instructions to practice the system in coordination with one another. Computer system 1300 may transmit and receive messages, data, and instructions, including program, i.e., application code, through communication link 1320 and communication interface 1312. Received program code may be executed by processor 1304 as it is received, and/or stored in disk drive 1310, or other nonvolatile storage for later execution.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

The invention claimed is:

1. A system for performing an operation on a multimedia document, the multimedia document using a multimodal input, the document and the operation being enhanced through analysis of the multimodal input, the system comprising:
a) a client; and
b) a system server.

2. The system recited in claim 1 wherein the operation comprises at least one of:
a) authoring the multimedia document;
b) managing the multimedia document;
c) retrieving the multimedia document based on a query;
d) accessing the multimedia document; or
e) presenting the multimedia document.

3. The system recited in claim 1 wherein the multimodal input comprises at least one of:
a) a multimedia content;
b) a metadata; or
c) a user input.

4. The system recited in claim 1 wherein the multimodal input is obtained from a source, the source comprising at least one of:
a) a real world environment;
b) a television screen;
c) a computer monitor;
d) a speaker; or
e) a storage.

5. The system recited in claim 1 wherein the client is integrated into a portable device.

6. The system recited in claim 1 wherein the system server is connected to the client over a communication network.

7. The system recited in claim 1 wherein the system server is integrated with the client on a device.

8. The system recited in claim 2 wherein the operation is performed using a website.

9. The system recited in claim 1 further comprising:
storing the document in the system.

10. The system recited in claim 1 further comprising a mechanism for communicating the document using a communication channel, wherein the communication channel comprises at least one of:
a) e-mail;
b) instant messaging;
c) MMS; or
d) SMS.

11. The system recited in claim 1 wherein the document is configured to include an information service.

12. The system recited in claim 1 wherein the document is classified into a classification.

13. The system recited in claim 1 wherein the document is shared between a plurality of users of the system.

14. The system recited in claim 1 wherein the system is configured to restrict the access to the document to a user of the system.

15. The system recited in claim 1 wherein the system is configured to include a financial transaction for performing the operation.

16. The system recited in claim 1 wherein the analysis of a multimodal input includes extraction of an embedded visual element from a visual content.

17. The system recited in claim 1 wherein the computer analysis of a multimodal input includes extraction of textual information from an audio content.

18. The system recited in claim 1 wherein the computer analysis uses information from a knowledge base.

19. A method for authoring a document comprising:
a) capturing a multimodal input;
b) extracting an embedded information from the multimodal content;
c) composing the document from the multimodal input content; and
d) storing the document in a documents database.

20. A method for retrieving and presentation of a document comprising:
a) capturing a multimodal input for generating a query;
b) extracting an embedded information from the multimodal input in the query;
c) identification of the document from a documents database matching the query;
d) communicating the identified document to a client; and
e) presenting the document on the client.
